(19) United States
(12) Patent Application Publication
(10) Pub. No.: US 2026/0187453 A1
(43) Pub. Date: Jul. 2, 2026

(54) MODEL TRAINING METHOD, TERMINAL DEVICE, AND NETWORK DEVICE

(71) Applicant: QUECTEL WIRELESS SOLUTIONS CO., LTD., Shanghai (CN)

(72) Inventors: Zheng ZHAO, Shanghai (CN); Qufang HUANG, Shanghai (CN); Jin LIU, Shanghai (CN)

(21) Appl. No.: 19/547,065

(22) Filed: Feb. 23, 2026

Related U.S. Application Data
(63) Continuation of application No. PCT/CN2024/082509, filed on Mar. 19, 2024.

(51) Int. Cl. G06N 3/08; G06N 3/0455; H04L 41/16; H04W 72/51

(52) U.S. Cl. CPC G06N 3/08; G06N 3/0455; H04L 41/16; H04W 72/51

(57) ABSTRACT

Provided are a model training method, a terminal device, and a network device. One example method includes: receiving a first model and first information from a network device; and selecting a first training mode from a plurality of training modes based on the first information, wherein the plurality of training modes are used together to train the first model, and the first training mode is used by the apparatus to perform at least one of uplink transmission or model training related to the first model.

### CROSS-REFERENCE TO RELATED APPLICATIONS

This application is a continuation of International Application No. PCT/CN2024/082509, filed on Mar. 19, 2024, the disclosure of which is hereby incorporated by reference in its entirety.

### TECHNICAL FIELD

The present application relates to the field of machine learning technologies, and more specifically, to a model training method, a terminal device, and a network device.

### BACKGROUND

With development of communication technologies, burden of data transmission in wireless networks can be significantly alleviated for some services with the support of intelligent models. For example, task-oriented semantic communication combined with a deep learning-based semantic codec model can support intelligent connection of a plurality of terminal devices.

However, terminal devices of different types or architectures have large differences in capabilities, and time required to train a same model also varies. Therefore, when a plurality of terminal devices jointly train a model, how to efficiently train the model is an urgent problem that needs to be solved.

### SUMMARY

The present application provides a model training method, a terminal device, and a network device. The following describes various aspects of embodiments of the present application.

According to a first aspect, a model training method is provided, including: receiving, by a first terminal device, a first model and first information sent by a network device; and selecting, by the first terminal device, a first training mode from a plurality of training modes based on the first information, where the plurality of training modes are used together to train the first model, and the first training mode is used by the first terminal device to perform uplink transmission and/or model training related to the first model.

According to a second aspect, a model training method is provided, including: sending, by a network device, a first model and first information to a first terminal device, where the first information is used by the first terminal device to select a first training mode from a plurality of training modes, the plurality of training modes are used together to train the first model, and the first training mode is used by the first terminal device to perform uplink transmission and/or model training related to the first model.

According to a third aspect, a terminal device is provided. The terminal device is a first terminal device, and the terminal device includes: a first receiving unit, receiving a first model and first information sent by a network device; and a first processing unit, selecting a first training mode from a plurality of training modes based on the first information, where the plurality of training modes are used together to train the first model, and the first training mode is used by the first terminal device to perform uplink transmission and/or model training related to the first model.

According to a fourth aspect, a network device is provided. The network device includes: a first sending unit, sending a first model and first information, where the first information is used by the first terminal device to select a first training mode from a plurality of training modes, the plurality of training modes are used together to train the first model, and the first training mode is used by the first terminal device to perform uplink transmission and/or model training related to the first model.

According to a fifth aspect, a communication apparatus is provided, including a memory and a processor. The memory is configured to store a program, and the processor is configured to invoke the program in the memory to execute a method according to the first aspect or the second aspect.

According to a sixth aspect, an apparatus is provided, including a processor configured to invoke a program from a memory to execute a method according to the first aspect or the second aspect.

According to a seventh aspect, a chip is provided, including a processor configured to invoke a program from a memory to cause a device on which the chip is installed to execute a method according to the first aspect or the second aspect.

According to an eighth aspect, a computer-readable storage medium is provided, where the computer-readable storage medium stores a program, and the program causes a computer to execute a method according to the first aspect or the second aspect.

According to a ninth aspect, a computer program product is provided, where the computer program product includes a program, and the program causes a computer to execute a method according to the first aspect or the second aspect.

According to a tenth aspect, a computer program is provided, where the computer program causes a computer to execute a method according to the first aspect or the second aspect.

In embodiments of the present application, a first terminal device determines a corresponding training mode from a plurality of training modes based on first information. The plurality of training modes are used by a plurality of terminal devices and a network device to collaboratively train a first model. The first terminal device can participate in training the first model based on the determined training mode. It can be learned that a model training method in embodiments of the present application includes a plurality of training modes, so that the first terminal device can select a training mode that matches the first terminal device, thereby improving efficiency in jointly training the first model by the plurality of terminal devices.

### BRIEF DESCRIPTION OF THE DRAWINGS

FIG. 1 shows a wireless communication system to which an embodiment of the present application is applied.

FIG. 2 is a schematic diagram of a codec model system applicable to semantic communication.

FIG. 3 is a schematic flowchart of a model training method according to an embodiment of the present application.

FIG. 4 is a schematic flowchart of a possible implementation of the method shown in FIG. 3.

FIG. 5 is a schematic flowchart of another possible implementation of the method shown in FIG. 3.

FIG. 6 is a schematic diagram of a training system for a semantic codec model according to an embodiment of the present application.

FIG. 7 is a schematic diagram of a structure of a terminal device according to an embodiment of the present application.

FIG. 8 is a schematic diagram of a structure of a control apparatus of the terminal device shown in FIG. 7.

FIG. 9 is a schematic diagram of a structure of a network device according to an embodiment of the present application.

FIG. 10 is a schematic diagram of a structure of a control apparatus of the network device shown in FIG. 9.

FIG. 11 is a schematic diagram of a structure of an electronic device according to an embodiment of the present application.

FIG. 12 is a schematic block diagram of a communication apparatus according to an embodiment of the present application.

### DETAILED DESCRIPTION OF EMBODIMENTS

The following describes the technical solutions in embodiments of the present application with reference to the accompanying drawings in embodiments of the present application. Apparently, the described embodiments are some rather than all of embodiments of the present application. Based on embodiments of the present application, all other embodiments obtained by a person of ordinary skill in the art without creative efforts fall within the protection scope of the present application.

Embodiments of the present application may be applied to various communication systems. For example, embodiments of the present application may be applied to a global system for mobile communications (global system of mobile communication, GSM), a code division multiple access (code division multiple access, CDMA) system, a wideband code division multiple access (wideband code division multiple access, WCDMA) system, a general packet radio service (general packet radio service, GPRS), a long term evolution (long term evolution, LTE) system, an advanced long term evolution (advanced long term evolution, LTE-A) system, a new radio (new radio, NR) system, an evolved system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, an NTN system, a universal mobile telecommunication system (universal mobile telecommunication system, UMTS), a wireless local area network (wireless local area networks, WLAN), wireless fidelity (wireless fidelity, WiFi), and a 5th generation (5th-generation, 5G) communication system. Embodiments of the present application may be further applied to another communication system, such as a future communication system. The future communication system may be, for example, a 6th generation (6th-generation, 6G) mobile communication system, or a satellite (satellite) communication system.

Conventional communication systems support a limited quantity of connections and are easy to implement. With the development of communications technologies, a communication system may support not only conventional cellular communication but also one or more other types of communication. For example, the communication system may support one or more types of the following communication: device-to-device (device-to-device, D2D) communication, machine-to-machine (machine-to-machine, M2M) communication, machine type communication (machine type communication, MTC), enhanced machine type communication (enhanced MTC, eMTC), vehicle-to-vehicle (vehicle-to-vehicle, V2V) communication, vehicle-to-everything (vehicle-to-everything, V2X) communication, and the like. The embodiments of the present application may also be applied to a communication system that supports the foregoing communication manners.

The communication system in embodiments of the present application may be applied to a carrier aggregation (carrier aggregation, CA) scenario, a dual connectivity (dual connectivity, DC) scenario, or a standalone (standalone, SA) networking scenario.

The communication system in embodiments of the present application may be applied to an unlicensed spectrum. The unlicensed spectrum may also be considered as a shared spectrum. Alternatively, the communication system in embodiments of the present application may be applied to a licensed spectrum. The licensed spectrum may also be considered as a dedicated spectrum.

Embodiments of the present application may be applied to an NTN system. For example, the NTN system may include a 4G-based NTN system, an NR-based NTN system, an internet of things (internet of things, IoT)-based NTN system, and a narrow band-internet of things (narrow band internet of things, NB-IoT)-based NTN system.

The communication system may include one or more terminal devices. The terminal device in embodiments of the present application may also be referred to as user equipment (user equipment, UE), an access terminal, a subscriber unit, a subscriber station, a mobile site, a mobile station (mobile station, MS), a mobile terminal (mobile Terminal, MT), a remote station, a remote terminal, a mobile device, a user terminal, a terminal, a wireless communication device, a user agent, a user apparatus, or the like.

In some embodiments, the terminal device may be a station (STATION, ST) in a WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device having a wireless communication function, a computing device or any other processing device connected to a wireless modem, a vehicle-mounted device, a wearable device, a terminal device in a next generation communication system (such as an NR system) or a terminal device in a future evolved public land mobile network (public land mobile network, PLMN), or the like.

In some embodiments, the terminal device may be a device providing a user with voice and/or data connectivity. For example, the terminal device may be a handheld device, a vehicle-mounted device, or the like having a wireless connection function. In some specific examples, the terminal device may be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like.

In some embodiments, the terminal device may be deployed on land. For example, the terminal device may be deployed indoors or outdoors. In some embodiments, the terminal device may be deployed on water, for example, on a ship. In some embodiments, the terminal device may be deployed in the air, for example, on an airplane, a balloon, and a satellite.

In addition to the terminal device, the communication system may further include one or more network devices. The network device in embodiments of the present application may be a device for communicating with the terminal device. The network device may also be referred to as an access network device or a wireless access network device. The network device may be, for example, a base station. The network device in embodiments of the present application may be a radio access network (radio access network, RAN) node (or device) that connects the terminal device to a wireless network. The base station may broadly cover following various names, or may be replaced with the following names: a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNodeB MeNB, a secondary eNodeB SeNB, a multi-standard radio (MSR) node, a home base station, a network controller, an access node, a wireless node, an access point (access point, AP), a transmission node, a transceiver node, a baseband unit (base band unit, BBU), a remote radio unit (Remote Radio Unit, RRU), an active antenna unit (active antenna unit, AAU), a remote radio head (remote radio head, RRH), a central unit (central unit, CU), a distributed unit (distributed unit, DU), a positioning node, or the like. The base station may be a macro base station, a micro base station, a relay node, a donor node, or the like, or a combination thereof. The base station may alternatively be a communication module, a modem, or a chip disposed in the foregoing device or apparatus. The base station may be alternatively a mobile switching center, a device that functions as a base station in D2D, V2X, and M2M communication, a network-side device in a 6G network, a device that functions as a base station in a future communication system, or the like. The base station may support networks with a same access technology or different access technologies. A specific technology and a specific device form used by the network device are not limited in embodiments of the present application.

The base station may be fixed or mobile. For example, a helicopter or an unmanned aerial vehicle may be configured to serve as a mobile base station, and one or more cells may move based on a location of the mobile base station. In other examples, a helicopter or an unmanned aerial vehicle may be configured to serve as a device in communication with another base station.

In some deployments, the network device in embodiments of the present application may be a CU or a DU, or the network device includes a CU and a DU. The gNB may further include an AAU.

As an example rather than limitation, in embodiments of the present application, the network device may have a mobile feature, for example, the network device may be a movable device. In some embodiments of the present application, the network device may be a satellite or a balloon station. In some embodiments of the present application, the network device may alternatively be a base station arranged on land, water, or the like.

In embodiments of the present application, the network device may provide a service for a cell, and the terminal device communicates with the network device by using a transmission resource (for example, a frequency resource or a spectrum resource) used by the cell. The cell may be a cell corresponding to the network device (for example, a base station).

The cell may belong to a macro base station or belong to a base station corresponding to a small cell (small cell). The small cell herein may include: a metro cell (metro cell), a micro cell (micro cell), a pico cell (pico cell), a femto cell (femto cell), or the like. These small cells have a small coverage range and low transmit power, and are suitable for providing a high-rate data transmission service.

In some embodiments, the present application may also be applied to an artificial intelligence communication system. One of goals of the 3rd generation partnership project (3rd generation partnership project, 3GPP) release 18 is to enhance functions of 5G and extend them to new devices, deployments, and industries. As network designs become increasingly complex, a wide range of deployments and usage options may be included, and conventional methods will not be capable of providing rapid solutions. Because manually reconfiguring a cellular communication system is costly and inefficient, it is necessary to automate an operation procedure by using artificial intelligence (artificial intelligence, AI) and machine learning (machine learning, ML), so as to reduce costs by automating functions that require human interaction. For example, AI and ML can use a large amount of data collected from wireless networks, to solve complex and unstructured network problems.

In an example, AI may be used in core networks and RANs to implement intelligent network operations. For example, AI may be used to enhance quality of service (quality of service, QoS), improve efficiency, simplify a deployment, and improve security.

In an example, artificial intelligence on devices will benefit an entire communication system. A potential supporting capability of AI is radio perception. AI may provide valuable knowledge through environmental and contextual perception, to reduce overheads and a delay. Through radio perception, the communication system can support enhanced device experience such as intelligent beamforming and power management. In addition, AI can help improve system performance, for example, reduce interference, achieve better spectrum utilization, and improve radio security. For example, AI can help better detect and prevent malicious attacks.

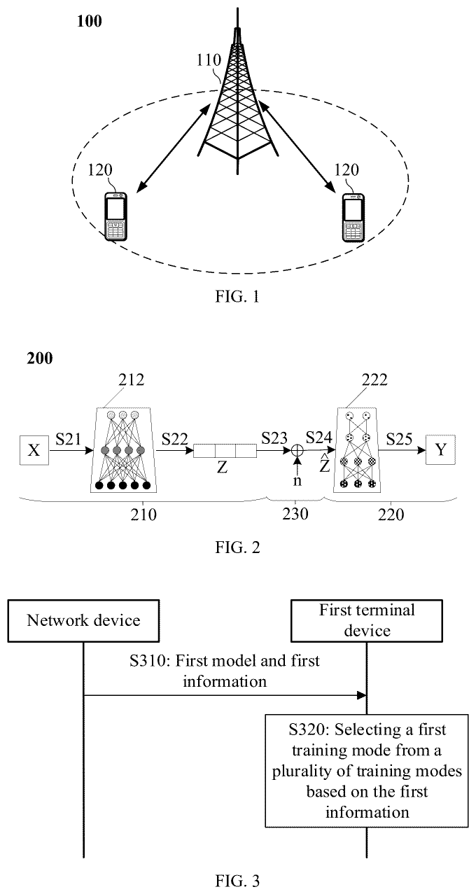

For example, FIG. 1 is a schematic diagram of an architecture of a communication system according to an embodiment of the present application. As shown in FIG. 1, a communication system 100 may include a network device 110, and the network device 110 may be a device that communicates with a terminal device 120 (or referred to as a communication terminal or a terminal). The network device 110 may provide communication coverage for a specific geographic region, and may communicate with a terminal device within the coverage region.

FIG. 1 illustrates one network device and two terminal devices. In some embodiments of the present application, the communication system 100 may include a plurality of network devices, and another quantity of terminal devices may be included within a coverage area of each network device, which is not limited.

In embodiments of the present application, the wireless communication system shown in FIG. 1 may further include other network entities such as a mobility management entity (mobility management entity, MME) and an access and mobility management function (access and mobility management function, AMF). This is not limited in embodiments of the present application.

It should be understood that a device having a communication function in a network/system in embodiments of the present application may be referred to as a communication device. The communication system 100 shown in FIG. 1 is used as an example. A communication device may include a network device 110 and a terminal device 120 having a communication function, and the network device 110 and the terminal device 120 may be specific devices described above. Details are not described herein again. The communication device may further include other devices in the communication system 100, such as a network controller, a mobility management entity, and other network entities. This is not limited in embodiments of the present application.

In order to facilitate detailed description of innovations of the technical solutions, some related technical knowledge in embodiments of the present application is first introduced. The following related technologies, as optional solutions, may be randomly combined with the technical solutions of embodiments of the present application, all of which fall within the protection scope of embodiments of the present application. Embodiments of the present application include at least a part of the following content.

With continuous development of communication technologies, burden of data transmission in wireless networks can be alleviated for some services with the support of intelligent models. For example, as an emerging communication paradigm in 6G networks, task-oriented semantic communication needs to transmit only task-related information. Therefore, data transmission burden of wireless networks can be significantly alleviated. Further, with support of deep learning-based semantic codec models, semantic communication can achieve intelligent connection of all things.

Task-oriented semantic communication is a task-based and “understand first, then transmit” communication method. A task-oriented semantic communication system usually includes a transmit end, a receive end, a wireless channel, original data, target data, a semantic encoder model, and a semantic decoder model. The semantic decoder model is also referred to as a semantic transcoder model. In default communication, the transmit end encodes the original data into a semantic signal by using the semantic encoder model; and the transmit end then transmits the semantic signal to the receive end; the receive end receives the semantic signal passing through a channel, and decodes the semantic signal passing through the channel into the target data by using the semantic decoder model.

For ease of understanding, illustration of a codec model system applicable to semantic communication is given below with reference to FIG. 2. The model system 200 in FIG. 2 includes a transmit end 210, a receive end 220, and a wireless channel 230.

Refer to FIG. 2. Step S21: The transmit end 210 inputs original data X into a semantic encoder model 212.
Step S22: The semantic encoder model 212 encodes the original data X into a semantic signal Z.
Step S23: The transmit end 210 transmits the semantic signal Z through the wireless channel 230.
Step S24: In consideration of noise n in the wireless channel 230, the semantic signal Z becomes a wireless semantic signal 2 after passing through the channel.
Step S25: The receive end 220 decodes the wireless semantic signal 2 into target data Y by using a semantic decoder model.

A codec model for semantic communication is described with reference to FIG. 2. Deep learning and training of intelligent models such as semantic codec models require a specific amount of data samples. However, data samples are distributedly stored in different terminal devices in a wireless edge network. Therefore, how to efficiently train the semantic codec model becomes a problem needing to be urgently solved.

Currently, methods for model training in wireless edge networks mainly include federated learning and centralized learning. The following uses a semantic codec model as an example to describe a federated learning system and a centralized learning system.

The centralized learning system can achieve centralized training of a deep learning-based semantic codec model. A centralized learning system in the wireless edge network also includes a base station and a plurality of terminal devices. First, each terminal device uploads a local data sample to the base station, and the base station uses collected data samples to train a global semantic codec model until the global semantic codec model meets a preset convergence condition or reaches a maximum preset number of training rounds, so as to complete an entire centralized learning process.

In the centralized learning system, the terminal device uploads its local data sample to a network device, which may lead to privacy data leakage. When an existing centralized learning system is deployed to train a semantic codec model, the local data sample uploaded by each terminal device includes privacy information related to the terminal device. Therefore, uploading the local data sample exposes private data of the terminal device to the base station, bringing a risk of privacy data leakage.

The federated learning system can achieve distributed training of a deep learning-based semantic codec model. Usually, a federated learning system in the wireless edge network includes a base station and a plurality of terminal devices. An entire training process is divided into a plurality of rounds. In each round of training, the base station broadcasts a global semantic codec model to all terminal devices. Each terminal device uses its local data to train the global semantic codec model to generate a local semantic codec model, and uploads the local semantic codec model to the base station through a wireless channel. Then the base station aggregates local semantic codec models uploaded by all the terminal devices to obtain the global semantic codec model. The process described above is repeated until the global semantic codec model meets the preset convergence condition or reaches the maximum preset number of training rounds, so as to complete an entire federated learning process.

In the federated learning system, although a problem of privacy data leakage in the centralized learning system can be solved, the local model is trained by each terminal device and computing resources on the base station side cannot be fully utilized. Specifically, when an existing federated learning system is deployed to train a semantic codec model, training of the semantic codec model is performed only at each terminal device. The base station is responsible only for aggregation and broadcasting of the semantic codec models, but does not train the semantic codec models, which severely wastes computing resources on the base station side.

The federated learning system and the centralized learning system are described above. Regardless of a learning system type, data or models need to be transmitted based on a communication system. In existing wireless communication, a terminal device mostly uses a digital communication manner, that is, original data is first encoded into a bit stream through source coding and channel coding, and then uploaded to a base station through a wireless channel; and the base station recovers the original data through source decoding and channel decoding. This process requires encoding of the original data into a high-dimensional bit stream, which causes a large delay and large overheads and reduce a transmission rate. It can be learned that data transmission based on digital communication is inefficient. Compared with transmission based on digital communication, data transmission based on over-the-air computation can effectively improve transmission efficiency.

Over-the-air computation is a new type of non-orthogonal access technology. In over-the-air computation, a plurality of terminal devices pre-process original signals and then transmit information simultaneously on a same time-frequency resource by using a superposition characteristic of a wireless channel. A signal received by a base station is superposition of signals transmitted by the plurality of terminal devices. The base station post-processes the received superimposed signal to obtain a target signal, thereby achieving signal transmission and computing. It may be learned that over-the-air computation requires specific pre-processing and post-processing at the transmit end and the receive end respectively. Through pre-processing and post-processing, over-the-air computation can achieve mutual unification of communication and computing processes in a communication process, thereby improving transmission efficiency.

Although over-the-air computation can improve transmission efficiency, over-the-air computation requires a plurality of terminal devices to send signals on a same time-frequency resource. However, terminal devices used for model training may be different. For terminal devices of different types or a same type, different terminal devices may have computing capabilities of different types, different performance, and different architectures, that is, computing capabilities of different terminal devices are heterogeneous.

Due to heterogeneous capabilities of different terminal devices, when executing training of a local semantic codec model in the foregoing federated learning system, different terminal devices take different amounts of time to complete the training. In an example, a terminal device with a strong computing capability requires a short time, whereas a terminal device with a weak computing capability requires a long time; and a difference in training time also increases with an increase of heterogeneity.

Therefore, the terminal device with a weak computing capability significantly extends a training delay of the federated learning system. That is, during distributed training based on a semantic codec model of federated learning, a system training delay is determined by a terminal device that takes a longest time to complete local model training. Therefore, when a plurality of terminal devices jointly train a model, how to efficiently train the model is an urgent problem that needs to be solved.

It should be noted that the foregoing problem of a long training delay of a codec model for semantic communication due to heterogeneous computing capabilities of different terminal devices is merely an example, and embodiments of the present application may be applied to any type of model training scenario in which model training efficiency is low due to heterogeneous computing capabilities of different terminal devices.

In view of the foregoing problem, embodiments of the present application propose a model training method. Through this method, a first terminal device can select, from a plurality of training modes for training a first model based on first information, a training mode corresponding to the first terminal device. The plurality of training modes may be used for terminal devices with different capabilities, thereby avoiding a problem of low training efficiency caused by heterogeneous capabilities of the plurality of terminal devices. When a computing capability of the first terminal device is weak, sufficient computing resources on a base station side can assist the first terminal device in model training, thereby reducing a training delay caused by the first terminal device. For ease of understanding, the model training method is described in detail below with reference to FIG. 3.

FIG. 3 is illustrated from a perspective of interaction between a first terminal device and a network device. The first terminal device is a device having a specific computing capability and communication capability in the terminal devices mentioned above. In some embodiments, the first terminal device may train a first model based on a local data sample. In some embodiments, the first terminal device may send the data sample and a trained model to the network device. In some embodiments, the first terminal device may receive the first model sent by the network device in a broadcast manner.

In some embodiments, the first terminal device may be any terminal device in a wireless edge network. The first terminal device may store a plurality of types of data samples. The data sample stored in the first terminal device may include a local data sample used for training the first model.

In some embodiments, the first terminal device may perform data processing by using the first model. For example, when the first model includes a semantic encoder model, the first terminal device may encode local data based on the encoder model to obtain a semantic signal. For example, when the first model includes a semantic decoder model, the first terminal device may decode the semantic signal based on the decoder model.

The first terminal device may be any terminal device in a plurality of terminal devices participating in training of the first model. For example, the plurality of terminal devices may train the first model together with the network device. For example, the plurality of terminal devices may train the first model.

In some embodiments, the first terminal device may store a plurality of local data samples to participate in training of the first model. In some embodiments, the plurality of terminal devices may train the first model based on local data samples. In some embodiments, the plurality of terminal devices may provide, to the network device, the local data samples for training the first model.

In some embodiments, the local data sample may be various data samples used by the first terminal device to train the first model. For example, the local data sample includes but is not limited to text, voice, image, video, and the like, which is not limited in embodiments of the present application.

In an example, the first terminal device may store a local data sample set having a plurality of samples. For example, when the model training system includes N+K terminal devices (N and K are both integers greater than or equal to 1), the N+K terminal devices can store N+K local data sample sets. The N+K local data sample sets have D₁, . . . , D_{N}, D_{N+1}, . . . D_{N+K} samples respectively, which may be expressed as:

$${D}_{1} = {\{ ( {x}_{1 , l} , {y}_{1 , l} ) \}}_{l = 1}^{{D}_{1}} , … , {D}_{N} = {\{ ( {x}_{N , l} , {y}_{N , l} ) \}}_{l = 1}^{{D}_{N}} , {D}_{N + 1} = {\{ ( {x}_{N + 1 , l} , {y}_{N + 1 , l} ) \}}_{l = 1}^{{D}_{N + 1}} , … , {D}_{N + K} = {\{ ( {x}_{N + K , l} , {y}_{N + K , l} ) \}}_{l = 1}^{{D}_{N + K}} ,$$

where x_{m,l} is original data of an 1^{th} sample at an m^{th} terminal device, and y_{m,l} is target data of the 1^{th} sample; and m is a natural number from 1 to N+K, 1 is a natural number from 1 to Dₘ, and Dₘ represents a total number of data samples of the m^{th} terminal device.

In some embodiments, a part or all of terminal devices communicating with the network device participate in model training.

The network device is any one of the communication devices described above that provide services for a plurality of terminal devices. In some embodiments, the network device is a communication device with a powerful computing capability. The network device may be the base station that broadcasts the global model to the plurality of terminal devices based on federated learning as described above, or may be the base station that trains the global model based on centralized learning as described above. This is not limited herein.

The network device may communicate with a plurality of terminal devices including the first terminal device. For example, the network device may receive data samples or local models sent by a plurality of terminal devices. For example, the network device may send a global model of a specific round to a plurality of terminal devices. For example, the network device may send a resource allocation strategy for model training or data transmission to a plurality of terminal devices.

In some embodiments, the network device may group a plurality of terminal devices to help the plurality of terminal devices determine how to train a model. For example, the network device may determine some terminal devices with a weaker capability based on capability information of a plurality of terminal devices, and instruct these terminal devices not to perform model training locally, thereby avoiding an excessively large delay.

Refer to FIG. 3. Step S310: The first terminal device receives a first model and first information sent by the network device.

The first model may be a machine learning model that supports a plurality of communication services. Optionally, the first model may be applied to a wireless edge network.

In some embodiments, the first model may be a codec model. That is, the first model may include an encoder model and a decoder model. The encoder model is used for encoding at the transmit end, and the decoder model is used for decoding at the receive end.

Optionally, the transmit end and the receive end may be two transceiver ends of a wireless communication link. For example, when the transmit end is a network device, the receive end may be a terminal device or a network device other than the transmit end. For example, when the transmit end is a terminal device, the receive end may be a network device or any terminal device other than the transmit end.

In some embodiments, the first model may be a codec model for semantic communication, which may also be referred to as a semantic codec model or a collaborative semantic codec model. For example, the first model may be a collaborative semantic codec model for semantic communication. An encoder model in the first model is used by the transmit end to perform semantic encoding on to-be-sent data to obtain a semantic signal. A decoder model in the first model is used by the receive end to receive the semantic signal and decode the semantic signal.

The first model may be any one or more of a plurality of neural network models, which is not limited in embodiments of the present application. Optionally, the first model includes but is not limited to: a convolutional neural network model, a recurrent neural network model, a variational autoencoder neural model, and the like.

The first model may be a model being trained. A training process of the first model may include a plurality of training cycles. The training cycle may refer to a round of training process or learning process, also referred to as a round or a learning round. For example, a t^{th} round is a training cycle t.

In some embodiments, a start time of a training cycle may be uniformly indicated by the network device. For example, the network device may send a model training start instruction to all terminal devices participating in training. The semantic codec model is used as an example. The model training start instruction may be implemented by using a “1” bit signal. When receiving the “1” bit, the first terminal device may start training of a local semantic codec model or a semantic encoding task of the original data; or when the “1” bit is not received, the first terminal device may wait and keep current behavior unchanged.

In some embodiments, duration of a training cycle may be determined based on a plurality of training modes of the first model and/or a plurality of terminal device groups. For example, duration of a training cycle is determined by largest duration consumed among a plurality of training modes running in parallel. For another example, duration of a training cycle is determined by time consumed by a group of terminal devices with a weaker computing capability. Illustration will be given subsequently with reference to a plurality of terminal device groups.

In some embodiments, a number of training cycles in an entire training process may be determined by the network device. For example, after determining that a number of rounds of training reaches a preset maximum value, the base station broadcasts a training termination instruction to all terminal devices participating in the training. For another example, after determining that training reaches convergence, the base station broadcasts a training termination instruction to all terminal devices participating in the training.

In an example, when the training cycle t=T, it is judged that the current training reaches the preset maximum quantity of rounds of training, where T is a maximum number of rounds of training.

In some embodiments, during a process of training the first model, the first model may be a model applied to any training cycle. That is, the first model may be a model trained in any training cycle. In some embodiments, the first model may be a model determined in a previous training cycle of any training cycle. That is, in any training cycle other a 1^{st} training cycle, the first model may be a model determined in the previous training cycle.

In some embodiments, the first model may be a global model to be trained in any training cycle. For example, the first model may be a global semantic codec model φₜ, θₜ broadcast by the base station to a plurality of terminal devices in a t^{th} round of training. φₜ may be a Q-dimensional real number vector, used to represent a global semantic encoder model, and θₜ may be an R-dimensional real number vector, used to represent a global semantic decoder model.

In some embodiments, the first model may be determined by the network device. For example, the network device may integrate information related to model training in the previous training cycle, to determine the first model used for a current training cycle. For example, the network device may determine the first model based on a training result of the previous training cycle. For example, the network device may determine, based on a training result of the current training cycle, a second model used for a next training cycle. For a last training cycle, the second model may be a final global model. For example, the network device may determine, based on the training result of the first model in the current training cycle, the second model to be trained in the next training cycle.

In an example, training of the first model may be performed jointly by the network device and a plurality of terminal devices including the first terminal device.

In some embodiments, the network device may send the first model to a plurality of terminal devices through broadcasting, so that all terminal devices participating in model training receive the first model. That is, the first terminal device may receive, through broadcasting, the first model sent by the network device.

In an example, the first terminal device may receive a global semantic encoder model and a global semantic decoder model through broadcasting.

In some embodiments, broadcasting the first model by the network device to a plurality of terminal devices may be a procedure included in the current training cycle. For example, a procedure of receiving a model may be used to determine start time of the current training cycle. For example, that the network device broadcasts the first model may indicate that the current training cycle starts. For another example, after the current training cycle starts, the network device broadcasts the first model.

In some embodiments, broadcasting the first model by the network device to a plurality of terminal devices may not belong to a procedure in the current training cycle. For example, the current training cycle starts only after all terminal devices receive the first model.

The first information may be sent directly by the network device, or may be indicated by a higher layer, which is not limited herein. For example, the network device may send the first information through broadcasting.

The first information is determined by the network device. Optionally, the network device may determine the first information based on a plurality of terminal devices participating in model training.

Step S320: The first terminal device selects a first training mode from a plurality of training modes based on the first information.

The training mode may be a mode in which one or more devices participating in training perform model training, which may also be referred to as a training manner.

The plurality of training modes are used together to train the first model. That is, training of the first model is performed not based on a single training mode, but based on a plurality of training modes. For example, the plurality of devices participating in training of the first model may jointly train the first model based on the plurality of training modes.

In some embodiments, the plurality of training modes may include a centralized training mode based on the centralized learning system and a distributed training mode based on the federated learning system described above, and may further include other modes for training a machine learning model.

Optionally, the plurality of training modes may include training of the first model by a part or all of terminal devices in a communication system. That is, the plurality of training modes may be determined based on a type or a number of terminal devices participating in training.

Optionally, the plurality of training modes may include training performed by the network device on a part or all of models in the first model. That is, the plurality of training modes may be determined based on types or a quantity of models, which the network device participates in training, in the first model. For example, the network device may participate in training of a part of models in the first model, or may participate in training of all models in the first model.

Optionally, the plurality of training modes may include collaborative training of the first model by a plurality of terminal devices and the network device.

In some embodiments, when the first model includes an encoder model and a decoder model, the plurality of training modes may include centralized training and distributed training. For example, the distributed training is respective training of the encoder model and the decoder model by a plurality of terminal devices. For example, the centralized training is training of the decoder model by the network device.

The first information is used by the first terminal device to determine the first training mode from the plurality of training modes. That is, the first terminal device may determine, based on the first information, the mode for training the first model.

In some embodiments, the first information is used to determine whether the first training mode includes centralized training of a part or all of models in the first model by the network device. In an example, when the first training mode includes the centralized training, the first terminal device does not directly train the first model; or when the first training mode does not include the centralized training, the first terminal device directly trains the first model. That is, the first terminal device may determine, based on the first information, whether to directly train the first model.

In an example, when the first training mode includes the centralized training, the first terminal device sends, to the network device, first data/a first signal used for the centralized training; or when the first training mode does not include the centralized training, the first terminal device trains the first model.

Optionally, the first data used for the centralized training may be local data of the first terminal device or processed data.

Optionally, the first signal used for the centralized training may be a signal converted by the first terminal device based on a local data sample, or may be a signal converted after processing local data, thereby avoiding privacy leakage during transmission. For example, when the first model is a semantic-oriented codec model, the first terminal device may input a local data sample into an encoder to obtain a semantic signal (first signal).

In some embodiments, the first information may include one or more types of information used for determining the first training mode. In an example, the first information may include a first threshold related to a terminal device capability, so that the first terminal device determines the first training mode based on the first information and a capability of the first terminal device. In an example, the first information may include a first condition, and when the first terminal device meets the first condition, the first training mode may instruct the first terminal device to directly train the first model; or when the first terminal device does not meet the first condition, the first training mode may instruct the first terminal device not to directly train the first model.

Optionally, when the first information includes the first threshold, if the capability of the first terminal device is lower than the first threshold, the first training mode includes centralized training of a part or all of models in the first models by the network device.

Optionally, the first threshold may be determined based on a capability parameter. For example, when the capability parameter is a processor frequency, the first threshold is a frequency threshold.

In some embodiments, the first information may include a grouping strategy for a plurality of terminal device groups. The plurality of terminal device groups in a one-to-one correspondence to a plurality of training modes. For example, the network device may divide a plurality of terminal devices participating in training into a plurality of terminal device groups based on the plurality of training modes. For another example, after receiving the grouping strategy, each terminal device may determine a device group to which each device belongs.

In an example, the grouping strategy in the first information is used by the first terminal device to determine the first training mode based on the terminal device group to which the first terminal device belongs. For example, the first terminal device may select, from the plurality of terminal device groups based on the grouping strategy, the terminal device group to which the first terminal device belongs.

In some embodiments, the grouping strategy in the first information may be determined based on capabilities and/or channel coefficients of the plurality of terminal devices. A capability of a terminal device may include a computing capability and/or a transmission capability of the terminal device.

In an example, a terminal device grouping strategy on the base station side may include but is not limited to: a processor frequency of each terminal device, a number of floating-point operations executed per second, a local data sample quantity, and the like. This is not limited in the present application.

For example, a processor of the terminal device includes various processors such as a central processing unit (central processing unit, CPU).

In an example, the network device may divide the plurality of terminal devices into a terminal device group with a strong computing capability and a terminal device group with a weak computing capability based on computing capabilities of the plurality of terminal devices. A terminal device with a strong computing capability is, for example, a computer, or a communication device with a similar capability, and a terminal device with a weak computing capability is, for example, a mobile phone, or a communication device with a similar capability. For brevity, the terminal device group with the strong computing capability is referred to as a first terminal device group, the terminal device group with the weak computing capability is referred to as a second terminal device group, and the network device is described by using a base station as an example.

For example, a training system for the first model may include 1 base station and N+K terminal devices. The base station uses the terminal device grouping strategy to group the N+K terminal devices. N terminal devices are grouped into the first terminal device group, and K terminal devices are grouped into the second terminal device group. The first terminal device may be an n^{th} terminal device in the N terminal devices, or may be a k^{th} terminal device in the K terminal devices, where n is any number from 1 to N, and k is any number from 1 to K. Therefore, Dₙ may represent a local data sample set of the n^{th} terminal device in the N terminal devices, and Dₖ may represent a local data sample set of the k^{th} terminal device in the K terminal devices.

In an example, when the first terminal device belongs to the second terminal device group, the first terminal device may not directly train the first model. When the first model is a semantic codec model, the first terminal device may perform semantic codec model training with assistance of sufficient computing resources on the base station side, thereby reducing a training delay of the semantic codec model. Specifically, the base station groups all terminal devices into the first terminal device group and the second terminal device group, and the two groups of devices respectively execute different training modes. A terminal device in the first terminal device group has a stronger computing capability, and training of the first model does not cause a large delay; a terminal device in the second terminal device group has a weaker computing capability, and the first model is trained with assistance of the base station, thereby avoiding a large delay and improving training efficiency.

It can be learned from the previous description that duration of a training cycle may be determined based on a plurality of terminal device groups. A training system for a semantic codec model is used as an example, and the training system may include a base station, a first terminal device group, and a second terminal device group. In one training cycle, a terminal device in the first terminal device group performs model training and model uploading; and a terminal device in the second terminal device group performs semantic signal extraction and uploading, and the base station performs centralized training and model aggregation. In this scenario, one training cycle may include a terminal device training cycle of the first terminal device group, a terminal device semantic signal extraction cycle of the second terminal device group, a terminal device model gradient uploading cycle of the first terminal device group, a terminal device semantic signal uploading cycle of the second terminal device group, a centralized semantic decoder model training cycle of the base station, and a global semantic codec model aggregation cycle of the base station.

In one training cycle, the terminal device training cycle of the first terminal device group and the terminal device model gradient uploading cycle of the first terminal device group are in a serial relationship, and form a cycle of the first terminal device group. The terminal device semantic signal extraction cycle of the second terminal device group and the terminal device semantic signal uploading cycle of the second terminal device group are in a serial relationship, and form a second terminal device group cycle. Further, the first terminal device group cycle and the second terminal device group cycle are in a parallel relationship, and form a terminal device cycle. The terminal device cycle, the centralized semantic decoder model training cycle of the base station, and the global semantic codec model aggregation cycle of the base station are in a serial relationship.

In some embodiments, computing capabilities or transmission capabilities of the plurality of terminal devices may be determined by a capability parameter of each terminal device. The capability parameter of each terminal device may include one or more of the following: a processor frequency, a maximum processor frequency, a number of floating-point operations, a local data sample quantity, a maximum uplink transmission power, and a maximum energy consumption budget.

In an example, a capability parameter of the first terminal device may include one or more of the following: a number of floating-point operations of the first terminal device, a local data sample quantity of the first terminal device, a maximum processor frequency of the first terminal device, a maximum uplink transmission power of the first terminal device, and a maximum energy consumption budget of the first terminal device.

For example, N+K terminal devices may separately report maximum processor frequencies

$${ϑ}_{1}^{max} , … , {ϑ}_{N}^{max} , {ϑ}_{N + 1}^{max} , … , {ϑ}_{N + K}^{max} ,$$

maximum uplink transmission powers

$${P}_{1}^{max} , … , {P}_{N}^{max} , {P}_{N + 1}^{max} , … , {P}_{N + K}^{max} ,$$

and maximum energy consumption budgets

$${E}_{1}^{max} , … , {E}_{N}^{max} , {E}_{N + 1}^{max} , … , {E}_{N + K}^{max} .$$

In some embodiments, the grouping strategy may be determined based on capabilities of the plurality of terminal devices participating in model training. In an example, the network device may collect capability information of the plurality of terminal devices to determine the first information. For example, the network device may send a resource data collection instruction or a capability information collection instruction to a plurality of terminal devices to trigger the plurality of terminal devices to send capability information. For another example, local resources that can be reported by a terminal device may include a maximum processor frequency, a maximum uplink transmission power, and a maximum energy consumption budget.

In an example, the network device may send a first instruction to the first terminal device to trigger the first terminal device to send the capability parameter. The first instruction may be a resource data collection instruction or a capability information collection instruction, or may be an instruction for achieve a similar requirement.

In some embodiments, the first instruction may be a signal sent by the base station and received by each terminal device. Optionally, the first instruction may be implemented by using a “1” bit signal. For example, when receiving the “1” bit, the terminal device can transmit a local resource on an orthogonal frequency resource and send an orthogonal pilot to the base station; or when the “1” bit is not received, the terminal device waits and keeps current behavior unchanged.

In some embodiments, the first information may be determined based on channel coefficients associated with the plurality of terminal devices. For example, each terminal device may send a pilot signal when sending a capability parameter, so that the network device can determine a channel coefficient. For another example, when receiving resource data, the base station may obtain a channel coefficient of each terminal device based on a received pilot signal.

Optionally, the pilot signal used for obtaining the channel coefficient of each terminal device may be an orthogonal pilot signal or a direct-sequence spread spectrum signal.

Optionally, methods for obtaining a channel coefficient include but are not limited to: zero-forcing channel estimation, least squares channel estimation, and the like. This is not limited in embodiments of the present application.

In some embodiments, the first information may be determined based on both capabilities and channel coefficients of the plurality of terminal devices. For example, when the first information includes the grouping strategy, the base station may group the terminal devices after receiving resource data of each terminal device and determining the channel coefficient.

The first training mode is used by the first terminal device to perform uplink transmission and/or model training related to the first model. For example, the first training mode may include any one or more training modes in the plurality of training modes, which is not limited herein.

In some embodiments, the uplink transmission related to the first model may refer to sending data, a signal, or a model parameter related to the first model to the network device by the first terminal device, which is not limited herein. For example, the first terminal device sends the first data/first signal to the network device. For another example, the first terminal device sends a model gradient to the network device.

In some embodiments, model training related to the first model may refer to locally training of a part or all of models in the first model by the first terminal device. That is, the first terminal device directly trains a part or all of models in the first model.

Optionally, the first training mode may include centralized training of a part or all of models in the first model by the network device. Alternatively, the first training mode may not include distributed training of a part or all of models in the first model by the first terminal device. In these scenarios, the first terminal device may be any terminal device in the second terminal device group.

Optionally, the first training mode may include distributed training of a part or all of models in the first model by the first terminal device. Alternatively, the first training mode may not include centralized training of a part or all of models in the first model by the network device. In these scenarios, the first terminal device may be any terminal device in the first terminal device group.

In some embodiments, when the first training mode is the distributed training, the first terminal device trains the first model based on a local data sample to obtain a first local model gradient. The first local model gradient is aggregated with another local model gradient based on over-the-air computation.

In an example, when the first model is a semantic codec model, the first local model gradient is a semantic codec model gradient.

In an example, a plurality of terminal devices participating in the distributed training separately upload, based on over-the-air computation, local model gradients obtained through training. For example, the plurality of terminal devices upload generated local semantic codec model gradients on a same time-frequency resource to the base station.

In some embodiments, when the first terminal device belongs to the first terminal device group, the first training mode executed by the first terminal device is the distributed training. For example, the first terminal device may train the first model within the terminal device training cycle, and upload, within the terminal device model gradient uploading cycle, a local model gradient obtained through training.

For ease of understanding, the following uses the semantic codec model as an example to illustrate the first training mode of the terminal device in the first terminal device group. A t^{th} round of training (training cycle t) is used as an example. In the terminal device training cycle, the N terminal devices in the first terminal device group can use local data sample sets D₁, D₂, . . . , D_{N} to train the global semantic codec model φₜ, θₜ to obtain N local semantic codec model gradients

$$[ {g}_{ϕ , t , 1}^{L} , {g}_{θ , t , 1}^{L} ] , [ {g}_{ϕ , t , 2}^{L} , {g}_{θ , t , 2}^{L} ] , … , [ {g}_{ϕ , t , N}^{L} , {g}_{θ , t , N}^{L} ] .$$

Optionally, in the terminal device training cycle, training performed by the plurality of terminal devices may include local semantic signal generation, distortion impact simulation, target data reconstruction, loss function calculation, and local model gradient related calculation.

In an example, the n^{th} terminal device in the first terminal device group may use a broadcast semantic encoder model and original data x_{n,l} to generate a local semantic signal. For example, the local semantic signal z_{t,n,l} may be expressed as:

$${z}_{t , n , l} = S ( {x}_{n , l} ; {ϕ}_{t} ) ,$$

z_{t,n,l} is an M-dimensional real signal vector with a mean of 1 and a variance of 0, M is an integer ≥1, and S(·) is a semantic encoding operation.

In an example, in order to simulate a distortion effect of a wireless channel on a semantic signal, the n^{th} terminal device in the first terminal device group may impose an influence factor on a locally generated semantic signal. For example, the terminal device may apply Gaussian white noise to the locally generated semantic signal. A signal

$${\hat{z}}_{t , n , l}^{L}$$

obtained after Gaussian white noise is applied may be expressed as:

$${\hat{z}}_{t , n , l}^{L} = {z}_{t , n , l} + {n}_{t , n , l}^{L} ,$$

where

$${n}_{t , n , l}^{L} ∼ N ( 0 , {σ}_{L}^{2} {I}_{M} )$$

represents real Gaussian white noise whose power is

$${σ}_{L}^{2} , {I}_{M}$$

represents an identity matrix.

In an example, the n^{th} terminal device in the first terminal device group may reconstruct target data by using

$${\hat{z}}_{t , n , l}^{L}$$

and the semantic decoder model obtained through broadcasting. For example, the reconstructed target data

$${\hat{y}}_{t , n , l}^{L}$$

may be expressed as:

$${\hat{y}}_{t , n , l}^{L} = {S}^{- 1} ( {\hat{z}}_{t , n , l}^{L} ; {θ}_{t} ) ,$$

where S⁻¹(·) is a semantic decoding operation.

In an example, the n^{th} terminal device in the first terminal device group may calculate a local loss function and train the received global semantic codec model by using a gradient descent method. For example, the local loss function

$${F}_{n}^{L} ( {ϕ}_{t} , {θ}_{t} )$$

may be expressed as:

$${F}_{n}^{L} ( {ϕ}_{t} , {θ}_{t} ) = \frac{1}{{D}_{n}} {\sum }_{l ∈ {D}_{n}} {f}_{t , n , l} ,$$

where ƒ_{t,n,l}=ƒ(φₜ, θₜ; x_{n,l}, y_{n,l}) is a local loss function of the n^{th} terminal device in the first terminal device group with respect to the original data x_{n,l} and the target data y_{n,l}.

Optionally, the local loss function includes but is not limited to: a cross entropy loss function, a mean squared error loss function, a hinge loss function, and the like. This is not limited in embodiments of the present application.

In an example, the n^{th} terminal device in the first terminal device group may calculate a local semantic codec model gradient based on the local loss function

$${g}_{t , n}^{L} = [ {g}_{ϕ , t , n}^{L} , {g}_{θ , t , n}^{L} ] .$$

For example, the encoder model gradient

$${g}_{ϕ , t , n}^{L}$$

and the decoder model gradient

$${g}_{θ , t , n}^{L}$$

may be expressed as:

$$\begin{matrix}{g}_{ϕ , t , n}^{L} = \frac{1}{{D}_{n}} {\sum }_{l ∈ {D}_{n}} {g}_{ϕ , t , n , l} ; and \\ {g}_{θ , t , n}^{L} = \frac{1}{{D}_{n}} {\sum }_{l ∈ {D}_{n}} {g}_{θ , t , n , l} ,\end{matrix}$$

where g_{φ,t,n,l}=∇_{Ø}ƒ_{t,n,l} and g_{θ}ƒ_{t,n,l}=∇_{θ}ƒ_{t,n,l} are respectively gradients, with respect to the original data x_{n,l} and the target data y_{n,l}, obtained by the n^{th} terminal device in the first terminal device group in the training cycle t, and both ∇_{Ø} and ∇_{θ} are gradient operators.

In an example, the n^{th} terminal device in the first terminal device group may calculate a mean and a mean square of the local semantic codec model gradient. For example, the mean

$${\overline{g}}_{t , n}^{L}$$

and the mean square

$${\overline{σ}}_{t , n}^{2}$$

may be expressed as:

$$\begin{matrix}{\overline{g}}_{t , n}^{L} = \frac{1}{Q + R} {\sum }_{q = 1}^{Q + R} {g}_{t , n , q}^{L} ; and \\ {\overline{σ}}_{t , n}^{2} = \frac{1}{Q + R} {\sum }_{q = 1}^{Q + R} {( {g}_{t , n , q}^{L} )}^{2} ,\end{matrix}$$

where

$${g}_{t , n , q}^{L}$$

is a q^{th} entry of a local semantic codec model gradient of the n^{th} terminal device in the first terminal device group, and both Q and R are integers greater than or equal to 1.

In an example, the N terminal devices in the first terminal device group may upload means and mean squares of local semantic codec model gradients to the base station. The base station may calculate a mean and a variance of a global semantic codec model gradient and broadcast the mean and the variance of the global semantic codec model gradient. For example, the mean \tilde{g}ₜ and the variance

$${\tilde{σ}}_{t}^{2}$$

may be expressed as:

$$\begin{matrix}{\tilde{g}}_{t} = \frac{1}{N} {\sum }_{n ∈ N} {\overline{g}}_{t , n}^{L} ; and \\ {\tilde{σ}}_{t}^{2} = \frac{1}{N} {\sum }_{n ∈ N} {\overline{σ}}_{t , n}^{2} - {\tilde{g}}_{t}^{2} .\end{matrix}$$

It can be learned from the foregoing description that, in the terminal device training cycle, the n^{th} terminal device in the first terminal device group may use the local data sample set to train a global semantic codec model. For example, the terminal device training cycle

$${τ}_{t , n}^{C}$$

of the first terminal device group may be expressed as:

$${τ}_{t , n}^{C} = \frac{{κ}_{n} {D}_{n}}{{ϑ}_{t , n}} ,$$

where ϑ_{t,n} is a central processing unit frequency assigned to the n^{th} terminal device in the first terminal device group in the t^{th} round of training, and κₙ is a number of central processing unit cycles required for training one data sample by the n^{th} terminal device in the first terminal device group.

The training cycle t is still used as an example. In the terminal device model gradient uploading cycle, the N terminal devices in the first terminal device group upload local semantic codec model gradients

$$[ {g}_{ϕ , t , 1}^{L} , {g}_{θ , t , 1}^{L} ] , [ {g}_{ϕ , t , 2}^{L} , {g}_{θ , t , 2}^{L} ] , … , [ {g}_{ϕ , t , N}^{L} , {g}_{θ , t , N}^{L} ]$$

the base station on a same time-frequency resource.

Optionally, in the model gradient uploading cycle, the plurality of terminal devices separately perform model gradient normalization processing, model gradient uploading, and the like.

In an example, the n^{th} terminal device in the first terminal device group may perform normalization processing on the local semantic codec model gradient. For example, a normalized local semantic codec model gradient signal s_{t,n} obtained by through normalization processing may be expressed as:

$${s}_{t , n} = \frac{{D}_{n}}{{D}_{p}} \frac{{g}_{t , n}^{L} - {\tilde{g}}_{t}}{{\tilde{σ}}_{t}} ,$$

where D_{P}=Σ_{nϵN} Dₙ, and D_{P} represents a total number of data samples of the first terminal device group.

In an example, the n^{th} terminal device in the first terminal device group may upload the normalized local semantic codec model gradient signal to the base station. For example, a power v_{t,n} for uploading the model gradient signal may be expressed as:

$${v}_{t , n} = {p}_{t , n} {s}_{t , n} ,$$

where p_{t,n} is an uplink transmission power of the n^{th} terminal device in the first terminal device group.

In an example, the N terminal devices in the first terminal device group may upload the local semantic codec model gradients to the base station on a same time-frequency resource based on over-the-air computation. For example, an uploading cycle

$${τ}_{t , n}^{U}$$

of the n^{th} terminal device may be expressed as:

$${τ}_{t , n}^{U} = ceil ( \frac{Q + R}{S} ) {T}_{subframe} ,$$

where S is a number of symbols that can be transmitted on each sub-channel within a unit subframe, T_{subframe} is duration of the unit subframe, and ceil(·) is a ceiling function.

In an example, the base station may receive a superimposed gradient signal. For example, the superimposed gradient signal yₜ may be expressed as:

$${y}_{t} = {\sum }_{n ∈ N} {h}_{t , n} {p}_{t , n} {s}_{t , n} + {n}_{t} ,$$

where h_{t,n} is a channel coefficient from the n^{th} terminal device in the first terminal device group to the base station, nₜ˜CN(0, σ²l_{Q+R}) is complex Gaussian white noise whose power is σ², and l_{Q+R} represents the identity matrix.

In an example, the base station applies a receiving scalar aₜ to the received superimposed gradient signal to obtain a federated learning-based aggregated semantic codec model gradient, that is, an aggregated model gradient. Optionally, the aggregate model gradient

$${\hat{g}}_{t}^{L}$$

may be expressed as:

$${\hat{g}}_{t}^{L} = [ {\hat{g}}_{ϕ , t}^{L} , {\hat{g}}_{θ , t}^{L} ] = {\tilde{σ}}_{t} ( {α}_{t} {\sum }_{n ∈ N} {h}_{t , n} {p}_{t , n} {s}_{t , n} + {α}_{t} {n}_{t} ) + {\tilde{g}}_{t} .$$

In some embodiments, when the first training mode is the centralized training, the first terminal device inputs the local data sample into the encoder model to obtain encoded first data/an encoded first signal. Further, the first terminal device sends the target data and the first data/first signal to the network device. The target data and the first data/first signal are used by the network device to train the decoder model.

Optionally, the target data and the first data/first signal may be as described above and are described in detail herein.

In some embodiments, when the first terminal device belongs to the second terminal device group, the first training mode executed by the first terminal device is the centralized training. For example, the first terminal device may obtain a to-be-sent semantic signal in the terminal device semantic signal extraction cycle, and upload the semantic signal in the terminal device semantic signal uploading cycle.

For ease of understanding, the following still uses the semantic codec model as an example to illustrate the first training mode of the terminal device in the second terminal device group. The t^{th} round of training (training cycle t) as an example, in the terminal device semantic signal extraction cycle of the second terminal device group, the K terminal devices in the second terminal device group use local data sample sets D_{N+1}, D_{N+2}, . . . , D_{N+K} and a global semantic encoder model φₜ to extract semantic signals

$${\{ {z}_{t , N + 1 , l} \}}_{l = 1}^{{D}_{N + 1}} , {\{ {z}_{t , N + 2 , l} \}}_{l = 1}^{{D}_{N + 2}} , … , {\{ {z}_{t , N + K , l} \}}_{l = 1}^{{D}_{N + K}}$$

of local data samples, where z_{t,N+k,l} is a semantic signal of an l^{th} sample in a k terminal device.

In an example, the k^{th} terminal device in the second terminal device group uses a broadcast semantic encoder and original data x_{N+k,l} to generate a local semantic signal. For example, a local semantic signal z_{t,N+k,l} generated by the k^{th} terminal device may be expressed as:

$${z}_{t , N + k , l} = S ( {x}_{N + k , l} ; {ϕ}_{t} ) ,$$

where z_{t,N+k,l} is an M-dimensional real signal vector with a mean of 1 and a variance of 0, and S(·) is a semantic encoding operation.

In an example, the k^{th} terminal device in the second terminal device group uses a local data sample set and the global semantic encoder model to extract a semantic signal of the local data sample. For example, an extraction cycle

$${τ}_{t , N + k}^{C}$$

of the semantic signal may be expressed as:

$${τ}_{t , N + k}^{C} = \frac{{κ}_{N + k} {D}_{N + k}}{{ϑ}_{t , N + k}} ,$$

where ϑ_{t,N+k} is a central processing unit frequency assigned to the k^{th} terminal device in the second terminal device group in the t^{th} round of training, and κ_{N+k} is a number of central processing unit cycles required for extracting a semantic signal of one data sample by the k^{th} terminal device in the second terminal device group.

The training cycle t is still used as an example. In the terminal device semantic signal uploading cycle, the K terminal devices in the second terminal device group upload separately their extracted semantic signals

$${\{ {z}_{t , N + 1 , l} \}}_{l = 1}^{{D}_{N + 1}} , {\{ {z}_{t , N + 2 , l} \}}_{l = 1}^{{D}_{N + 2}} , … , {\{ {z}_{t , N + K , l} \}}_{l = 1}^{{D}_{N + K}}$$

and original target data

$${\{ {y}_{t , N + 1 , l} \}}_{l = 1}^{{D}_{N + 1}} , {\{ {y}_{t , N + 2 , l} \}}_{l = 1}^{{D}_{N + 2}} , … , {\{ {y}_{t , N + K , l} \}}_{l = 1}^{{D}_{N + K}}$$

to the base station on different frequency resources. The base station may receive the wireless semantic signals

$${\{ \}}_{l = 1}^{{D}_{N + 1}} , {\{ \}}_{l = 1}^{{D}_{N + 2}} , … , {\{ \}}_{l = 1}^{{D}_{N + K}}$$

and the target data

$${\{ {y}_{t , N + 1 , l} \}}_{l = 1}^{{D}_{N + 1}} , {\{ {y}_{t , N + 2 , l} \}}_{l = 1}^{{D}_{N + 2}} , … , {\{ {y}_{t , N + K , l} \}}_{l = 1}^{{D}_{N + K}}$$

transmitted through wireless channels.

In an example, the k^{th} terminal device in the second terminal device group uploads an extracted semantic signal. For example, a power v_{t,N+k,l} for uploading the semantic signal may be expressed as:

$${v}_{t , N + k , l} = {p}_{t , N + k} {z}_{t , N + k , l} ,$$

where p_{t,N+k} is an uplink transmission power of the k^{th} terminal device in the second terminal device group.

In an example, a cycle

$${τ}_{t , N + k}^{U}$$

for uploading the extracted semantic signal by the k^{th} terminal device in the second terminal device group may be expressed as:

$${τ}_{t , N + k}^{U} = ceil ( \frac{{MD}_{N + k}}{S} ) {T}_{subframe} .$$

In an example, an original semantic signal y_{t,N+k,l} received by the base station may be expressed as:

$${y}_{t , N + k , l} = {h}_{t , N + k} {p}_{t , N + k} {z}_{t , N + k , l} + {n}_{t , N + k , l} ,$$

where n_{t,N+k,l}˜CN(0, σ²l_{M}) is complex Gaussian white noise whose power is σ², and h_{t,N+k} represents a channel coefficient of the k^{th} terminal device.

In an example, the base station obtains the wireless semantic signal by using the received original semantic signal. For example, the wireless semantic signal

$${\hat{z}}_{t , N + k , l}^{C}$$

may be expressed as:

$${\hat{z}}_{t , N + k , l}^{C} = {z}_{t , N + k , l} + \frac{{n}_{t , N + k , l}}{{h}_{t , N + k} {p}_{t , N + k}} .$$

It can be learned from the foregoing description that when the first training mode is the centralized training, the base station needs to train at least a part of models in the first model; or when the first training mode is the distributed training, the base station receives an aggregated model obtained after the plurality of terminal devices perform training.

In some embodiments, when the first model is a semantic codec model, the base station trains the decoder model to reduce a training delay. For example, the base station uses the received wireless semantic signal to train the global semantic decoder model to obtain a centralized semantic decoder model gradient.

In some embodiments, the distributed training may determine an aggregated model gradient obtained after aggregating a plurality of local model gradients in a current training cycle. For example, the base station may receive or determine the aggregated model gradient obtained after aggregating the plurality of local model gradients in the current training cycle.

In some embodiments, the centralized training may determine a centralized model gradient obtained after training the decoder model in the current training cycle. For example, the base station trains the decoder model to determine the centralized model gradient obtained after training the decoder model in the current training cycle.

In some embodiments, the aggregated model gradient and the centralized model gradient are used together to determine a second model to be trained in a next training cycle. For example, the base station determines, based on the aggregated model gradient and the centralized model gradient, the second model used for the next training cycle.

In the foregoing illustration of the terminal devices participating in training, the signal reception and processing performed by the base station are already described. For ease of understanding, the following still uses the semantic codec model as an example to illustrate model training and model processing performed by the base station in the training system.

The training cycle t is used as an example. In the centralized semantic decoder model training cycle of the base station, the base station may use received wireless semantic signals

$${\{ \}}_{l = 1}^{{D}_{N + 1}} , {\{ \}}_{l = 1}^{{D}_{N + 2}} , … , {\{ \}}_{l = 1}^{{D}_{N + K}}$$

to train the global semantic decoder model to obtain a centralized semantic decoder model gradient

$${g}_{θ , t}^{C} .$$

In an example, the base station calculates a global loss function and trains the global semantic decoder model by using the gradient descent method. For example, the global loss function F^{c}(φₜ, θₜ) may be expressed as:

$${F}^{C} ( {ϕ}_{t} , {θ}_{t} ) = \frac{1}{{D}_{W}} {\sum }_{k ∈ κ} {\sum }_{l ∈ {D}_{k}} {f}_{t , N + k , l} ,$$

where

$${f}_{t , N + k , l} = f ( {ϕ}_{t} , {θ}_{t} ; {\hat{z}}_{t , N + k , l}^{C} , {y}_{N + k , l} )$$

is a loss function with respect to the wireless semantic signal

$${\hat{z}}_{t , N + k , l}^{C}$$

and the target data y_{N+k,l} when the base station trains the centralized semantic decoder model, D_{W}=Σ_{kϵK} D_{N+k}, and D_{W} represents a total number of data samples in the second terminal device group.

In an example, a global semantic decoder model gradient

$${g}_{θ , t}^{C}$$

calculated by the base station based on the global loss function may be expressed as:

$${g}_{θ , t}^{C} = \frac{1}{{D}_{W}} {\sum }_{k ∈ κ} {\sum }_{l ∈ {D}_{k}} {g}_{θ , t , N + k , l}^{C} ,$$

where g_{θ,t,k,l}=∇_{θ}ƒ_{t,k,l} is a gradient of a loss function with respect to the global semantic codec model.

In a base station global semantic codec model aggregation cycle in the training cycle t, the base station may use a federated learning-based aggregated semantic codec model gradient

$$[ {\hat{g}}_{ϕ , t}^{L} , {\hat{g}}_{θ , t}^{L} ]$$

and a centralized semantic decoder model gradient

$${g}_{θ , t}^{C}$$

to update the global semantic codec model φₜ, θₜ, so as obtain a global semantic codec model φₜ₊₁, θₜ₊₁ for a next round of training. That is, when the encoder model in the first model is φₜ and the decoder model is θₜ, an encoder model φₜ₊₁ and a decoder model in the second model θₜ₊₁ may be expressed as:

$${ϕ}_{t + 1} = {ϕ}_{t} - γ {\hat{g}}_{ϕ , t}^{L} ; and$$

$${θ}_{t + 1} = {θ}_{t} - \frac{γ ( {D}_{P} {\hat{g}}_{θ , t}^{L} + {D}_{W} {g}_{θ , t}^{C} )}{D} ,$$

where γ represents a training learning rate of the first model in the current training cycle, D_{P} represents a total number of data samples of all terminal devices that perform the distributed training, D_{W} represents a total number of data samples of all terminal devices that perform the centralized training, D=D_{P}+D_{W},

$${\hat{g}}_{ϕ , t}^{L}$$

represents an encoder model gradient in the aggregated model gradient,

$${\hat{g}}_{θ , t}^{L}$$

represents a decoder model gradient in the aggregated model gradient, and

$${g}_{θ , t}^{C}$$

represents the centralized model gradient.

It can be learned from FIG. 3 that the first terminal device may select the first training mode based on the first information. A plurality of terminal devices may separately select appropriate training modes to avoid delay differences caused due to that terminal devices of different types or with different capabilities perform a same task. A collaborative semantic codec model for semantic communication is used as an example. The model training system may offload a training task of a terminal device with a weak computing capability to the base station, and utilize sufficient computing resources on the base station side to effectively alleviate impact of the terminal device with a weak computing capability on an overall training delay of semantic codec model. Further, this method can reduce the training delay of the semantic codec model and improve performance of the global semantic codec model. In addition, each terminal device in a plurality of terminal device groups does not transmit original data, which can effectively prevent privacy leakage of the terminal devices.

However, if terminal devices in a same terminal device group use different resource allocation strategies to execute the first training mode, a larger time difference may still be caused. In order to perform model training more efficiently, an embodiment of the present application proposes a resource allocation mechanism for a model training system to achieve collaborative resource allocation for terminal devices and improve computing and transmission efficiency.

In some embodiments, the first terminal device may receive second information sent by the network device. The second information is used by the first terminal device to determine a resource allocation strategy for executing the first training mode. That is, the network device may indicate, to the first terminal device, a related resource configuration for participating training of the first model, so that execution progress of a plurality of terminal devices is relatively synchronized.

In some embodiments, the resource allocation strategy may be used to determine an uplink transmission power, an energy consumption budget, and/or a processor frequency for executing the first training mode by the first terminal device.

Optionally, the resource allocation strategy may include a central processing unit frequency allocation strategy and/or an uplink transmission power allocation strategy.

In some embodiments, the second information is determined based on capability parameters of a plurality of terminal devices for training the first model.

Optionally, generation criteria of the grouping strategy and the resource allocation strategy executed on the base station side are the same. For example, the generation criteria of the resource allocation strategy include but are not limited to: a processor frequency of each terminal device, a number of floating-point operations executed per second, a local data sample quantity, and the like.

In some embodiments, the first information may include the second information. That is, the second information may be sent together with the first information. For example, after the base station generates a terminal device grouping strategy and a central processing unit frequency and uplink transmission power allocation strategy, the base station may broadcast the strategies to each terminal device. This is not limited in embodiments of the present application.

In an example, after generating completing a terminal device grouping strategy and the uplink transmission power a central processing unit frequency allocation strategy of each terminal device, the base station transmits grouping information of each terminal device and the central processing unit frequency and uplink transmission power allocation strategy through broadcast information.

In some embodiments, the second information may be sent separately. For example, the base station sends the resource allocation strategy after sending the grouping strategy.

In an example, when the first training mode is the distributed training, the first terminal device is a terminal device in the first terminal device group.

For example, the uplink transmission power p_{t,n} of the n^{th} terminal device in the first terminal device group may be expressed as:

$${P}_{t , n} = \frac{{( {α}_{t} {h}_{t , n} )}^{H}}{{\vert {α}_{t} {h}_{t , n} \vert}^{2}} {min}_{i ∈ N} ( \frac{{D}_{P}}{{D}_{i}} \vert {α}_{t} {h}_{t , i} \vert \sqrt{{P}_{i}^{max}} ) ,$$

where i represents any number from 1 to N and is used to determine a minimum value in the N terminal devices, and a received scalar at may be determined as:

$${α}_{t} = \frac{1}{{min}_{i ∈ N} ( \frac{{D}_{P}}{{D}_{i}} \vert {h}_{t , i} \vert \sqrt{{P}_{i}^{max}} )} .$$

For example, energy

$${E}_{t , n}^{U}$$

consumed for uplink transmission of the n^{th} terminal device in the first terminal device group may be expressed as:

$${E}_{t , n}^{U} = {τ}_{t , n}^{U} \frac{{D}_{n}^{2}}{{D}_{P}^{2}} {\vert {p}_{t , n} \vert}^{2} .$$

For example, a central processing unit frequency ϑ_{t,n} of the n^{th} terminal device in the first terminal device group may be expressed as:

$${ϑ}_{t , n} = min \{ {ϑ}_{n}^{max} , \sqrt{\frac{( {E}_{n}^{max} - {E}_{t , n}^{U} )}{{ϛ}_{n} {κ}_{n} {D}_{n}}} \} ,$$

where [symbol] ₙ is an energy consumption coefficient of a central processor of the n^{th} terminal device in the first terminal device group, and

$${E}_{n}^{max}$$

is a maximum energy consumption budget of the central processor of the n^{th} terminal device located in the first terminal device group.

In an example, when the first training mode is the centralized training, the first terminal device is a terminal device in the second terminal device group. For example, the uplink transmission power p_{t,N+k} of the k^{th} terminal device in the second terminal device group may be expressed as:

$${p}_{t , N + k} = \frac{{σ}_{0} {h}_{N + k}^{H}}{{σ}_{L} {\vert {h}_{t , N + k} \vert}^{2}} .$$

For example, energy

$${E}_{t , N + k}^{U}$$

consumed for uplink transmission of the k^{th} terminal device in the second terminal device group may be expressed as:

$${E}_{t , N + k}^{U} = {τ}_{t , N + k}^{U} {\vert {p}_{t , N + k} \vert}^{2} .$$

For example, a central processing unit frequency ϑ_{t,N+k} of the k^{th} terminal device in the second terminal device group may be expressed as:

$${ϑ}_{t , N + k} = min \{ {ϑ}_{N + k}^{max} , \sqrt{\frac{( {E}_{N + k}^{max} - {E}_{t , N + k}^{U} )}{ϛN + {k}^{κ} N + {k}^{D} N + k}} \} ,$$

where [symbol] _{N+k} is an energy consumption coefficient of a central processor of the k^{th} terminal device in the second terminal device group, and

$${E}_{N + k}^{max}$$

is a maximum energy consumption budget of the central processor of the k^{th} terminal device located in the second terminal device group.

In some embodiments, after completing resource allocation, the first terminal device may send a resource allocation complete instruction to the base station. Optionally, resource allocation complete instructions may use a same number of “1” bit signals as a number of terminal devices and be transmitted on orthogonal frequencies. When receiving a “1” bit from the n^{th} terminal device, the base station determines that the n^{th} terminal device has completed resource allocation; or when a “1” bit is not received from the n^{th} terminal device, the base station determines that the n^{th} terminal device has not completed resource allocation.

It can be learned from the foregoing description that in a resource allocation mechanism of the training system for the collaborative semantic codec model, on the one hand, the first terminal device group allocates an uplink transmission power based on a channel inversion technology, and the second terminal device group allocates an uplink transmission power based on a wireless channel coefficient to ensure that a semantic signal received by the base station reaches a default signal-to-noise ratio. On the other hand, each terminal device group allocates a central processing unit frequency to efficiently complete training of a local semantic codec model or a semantic encoding task of original data.

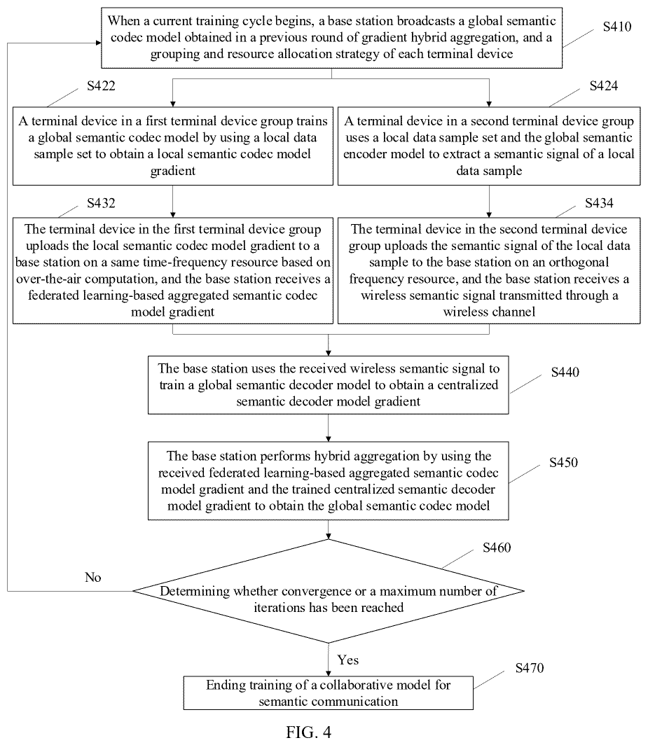

For ease ofunderstanding, the following describes, respectively with reference to FIG. 4 and FIG. 5, a training mechanism and a resource allocation mechanism for a collaborative semantic codec model for semantic communication to which an embodiment of the present application applies.

As shown in FIG. 4, a procedure of the training mechanism for the collaborative semantic codec model includes steps S410 to S470.

Step S410: When a current training cycle begins, a base station broadcasts a global semantic codec model (first model) obtained in a previous round of gradient hybrid aggregation, and a grouping and resource allocation strategy of each terminal device. One training cycle includes a terminal device training cycle and model gradient uploading cycle of a first terminal device group, a terminal device semantic signal extraction cycle and semantic signal uploading cycle of a second terminal device group, a centralized semantic decoder model training cycle of the base station, and a global semantic codec model aggregation cycle of the base station.

In some embodiments, when the current training cycle t starts, the base station broadcasts the global semantic codec model obtained in the previous round of gradient hybrid aggregation, and broadcasts the grouping strategy and a central processing unit frequency and uplink transmission power allocation strategy of each terminal device to each terminal device. Each terminal device determines a device category based on the received grouping strategy, and allocates a central processing unit frequency and an uplink transmission power based on the central processing unit frequency and uplink transmission power allocation strategy.

Step S422: A terminal device in the first terminal device group trains the global semantic codec model by using a local data sample set to obtain a local semantic codec model gradient.

Step S424: A terminal device in the second terminal device group uses a local data sample set and the global semantic encoder model to extract a semantic signal of a local data sample.

Step S432: The terminal device in the first terminal device group uploads the local semantic codec model gradient to the base station on a same time-frequency resource based on over-the-air computation, and the base station receives a federated learning-based aggregated semantic codec model gradient.

Step S434: The terminal device in the second terminal device group uploads the semantic signal of the local data sample to the base station on an orthogonal frequency resource, and the base station receives a wireless semantic signal transmitted through a wireless channel.

Step S440: The base station uses the received wireless semantic signal to train the global semantic decoder model to obtain a centralized semantic decoder model gradient.

Step S450: The base station performs hybrid aggregation by using the received federated learning-based aggregated semantic codec model gradient and the trained centralized semantic decoder model gradient to obtain the global semantic codec model.

Step S460: Determining whether convergence or a preset maximum number of iterations has been reached. That is, the base station determines whether training of the cooperative semantic codec model for semantic communication has reached a preset maximum number of rounds of training. If yes, perform step S470; if no, return to step S410.

Step S470: Ending training of the collaborative semantic codec model for semantic communication. After determining that a number of rounds of training reaches a preset maximum value, the base station broadcasts a training termination instruction to all terminal devices.

It can be learned from FIG. 4 that, in the training system for the collaborative semantic codec model for semantic communication, on the one hand, the first terminal device group performs local training of the semantic codec model, and uploads, based on over-the-air computation, the local semantic codec model gradient to the base station for aggregation, and the base station obtains the federated learning-based aggregated semantic codec model gradient. On the other hand, the second terminal device group performs semantic encoding of the local data sample, and uploads target data in the local data sample and an encoded semantic signal to the base station.

In the example of FIG. 4, the training mechanism for the collaborative semantic codec model for semantic communication can increase a quantity of local data samples participating in model training in each round of training, and achieve the hybrid aggregation of the local semantic codec model and the semantic codec model on the base station side, improving global model performance. On the one hand, in each round of training, the base station receives target data and a semantic signal from the second terminal device group, and performs centralized training of a semantic decoder model to obtain a centralized semantic decoder model. On the other hand, the base station uses the received federated learning-based aggregated semantic encoder model gradient and the centralized semantic decoder model gradient to update the global semantic decoder model. Finally, the base station obtains a global semantic codec model trained in this round.

As shown in FIG. 5, a procedure of the resource allocation mechanism of the training procedure for the collaborative semantic codec model includes steps S510 to S550.

Step S510: A base station broadcasts a resource data collection instruction to each terminal device, each terminal device reports a local resource and sends a pilot signal, and the base station receives resource data and obtains a channel coefficient of each terminal device based on the received pilot signal.

Step S520: The base station groups all terminal devices into a first terminal device group and a second terminal device group based on the received resource data and the channel coefficient of each terminal device, and generates an uplink transmission power and central processing unit frequency allocation strategy for each terminal device.

Step S530: The base station broadcasts grouping information and the central processing unit frequency and uplink transmission power allocation strategy of each terminal device to each terminal device, and each terminal device receives the grouping information and the central processing unit frequency and uplink transmission power allocation strategy.

Step S540: Each terminal device determines a device category based on the received grouping strategy, and allocates a central processing unit frequency and an uplink transmission power based on the central processing unit frequency and uplink transmission power allocation strategy.

Step S550: Each terminal device completes resource allocation and reports a resource allocation complete instruction to the base station, to end resource allocation for training of the collaborative semantic encoder model, the base station broadcasts a model training start instruction, and each terminal device performs corresponding model training and a corresponding transmission task based on the grouping.

It can be learned from FIG. 5 that the resource allocation mechanism for training of the collaborative semantic codec model in this embodiment of the present application can achieve collaborative resource allocation of terminal devices and improve computing and transmission efficiency. The first terminal device group allocates an uplink transmission power based on a channel inversion technology to achieve accurate over-the-air computation-based gradient signal transmission and aggregation, and the second terminal device group allocates an uplink transmission power based on a wireless channel coefficient to achieve accurate transmission of a semantic signal. The terminal device groups collaboratively allocate the central processing unit frequency to achieve efficient execution of training of a local semantic codec model and a semantic encoding task of original data.

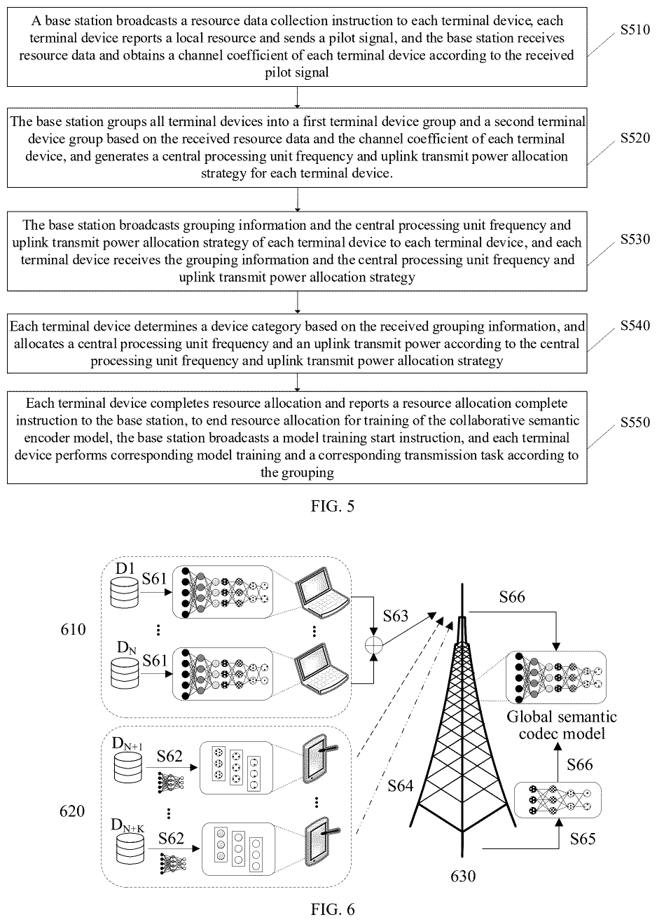

The following describes embodiments of the present application in more detail with reference to FIG. 6 as a specific example. It should be noted that the examples in FIG. 3 and FIG. 5 are merely intended to help a person skilled in the art understand embodiments of the present application, and are not intended to limit embodiments of the present application to a specific value or a specific scenario that is exemplified. Apparently, a person skilled in the art may make various equivalent modifications or changes based on the examples given in FIG. 3 and FIG. 5, and such modifications or changes also fall within the scope of embodiments of the present application.

FIG. 6 is a schematic diagram of a structure of a training system for a collaborative semantic codec model for semantic communication. As shown in FIG. 6, the training system includes a base station 630 and N+K terminal devices, and local data sample sets of the N+K terminal devices are D₁, . . . , D_{N}, D_{N+1}, . . . , D_{N+K} respectively. N terminal devices form a first terminal device group 610, and K terminal devices form a second terminal device group 620. A training process shown in FIG. 6 is divided into several training cycles. In a training cycle t, the N+K terminal devices may receive a first model broadcast by the base station 630.
S61: The first terminal device group 610 trains the first model based on local data samples to obtain N model gradients.
S62: The second terminal device group 620 performs semantic encoding based on the local data samples to obtain K groups of semantic signals.
S63: Aggregating the N model gradients based on over-the-air computation to obtain an aggregated model gradient, and sending the aggregated model gradient the base station.
S64: Separately sending the K groups of semantic signals and target data to the base station.
S65: The base station performs centralized training based on the K groups of semantic signals and the target data to obtain a centralized model gradient.
S66: Performing hybrid aggregation on the aggregated model gradient and the centralized model gradient to obtain a second model.

An embodiment of the present application further proposes a model learning system. The learning system includes a network device and a plurality of terminal devices. Any one of the plurality of terminal devices executes a method for execution by the first terminal device in the method described above, and the network device executes a method for execution by the network device in the method described above.

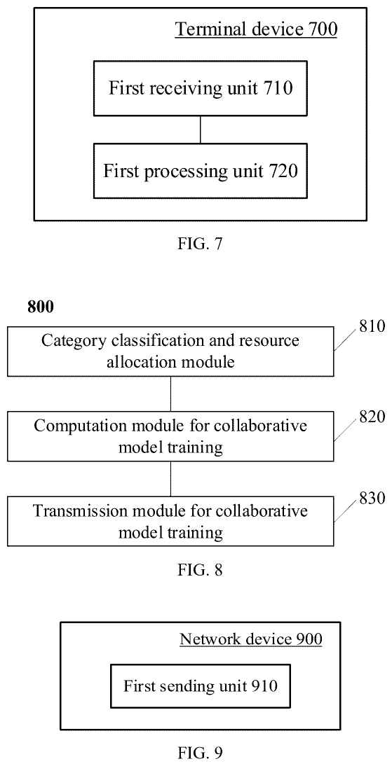

The foregoing describes the method embodiments of the present application in detail with reference to FIG. 1 to FIG. 6. Apparatus embodiments of the present application are described in detail below with reference to FIG. 7 to FIG. 12. It should be understood that the descriptions of the apparatus embodiments correspond to the descriptions of the method embodiments, and therefore, for parts that are not described in detail, refer to the foregoing method embodiments.

FIG. 7 is a schematic block diagram of a terminal device according to an embodiment of the present application. The terminal device 700 may be a first terminal device used for model training. The first terminal device may be any type of terminal device described above. A terminal device 700 shown in FIG. 7 includes a first receiving unit 710 and a first processing unit 720.

The first receiving unit 710 may be configured to receive a first model and first information sent by a network device.

The first processing unit 720 may be configured to select a first training mode from a plurality of training modes based on the first information, where the plurality of training modes are used together to train the first model, and the first training mode is used by the first terminal device to perform uplink transmission and/or model training related to the first model.

Optionally, the first information is used to determine whether the first training mode includes centralized training of a part or all of models in the first model by the network device, and the terminal device 700 further includes a first sending unit, which may be configured to: when the first training mode includes the centralized training, send, to the network device, first data/a first signal used for model training; and a second processing unit, which may be configured to: when the first training mode does not include the centralized training, train the first model.

Optionally, the first information includes a first threshold related to a terminal device capability, and when a capability of the first terminal device is lower than the first threshold, the first training mode includes the centralized training of a part or all of models in the first model by the network device.

Optionally, the plurality of training modes are in a one-to-one to correspondence with a plurality of terminal device groups, the first information includes a grouping strategy for the plurality of terminal device groups, and the grouping strategy is used by the first terminal device to determine the first training mode based on a terminal device group to which the first terminal device belongs.

Optionally, the first terminal device is one of a plurality of terminal devices for training the first model, and the grouping strategy is determined based on capabilities and/or channel coefficients of the plurality of terminal devices.

Optionally, the terminal device 700 further includes a second sending unit, which may be configured to second a capability parameter to the network device, and the capability parameter includes one or more of the following: a number of floating-point operations of the first terminal device, a local data sample quantity of the first terminal device, a maximum processor frequency of the first terminal device, a maximum uplink transmission power of the first terminal device, and a maximum energy consumption budget of the first terminal device.

Optionally, the terminal device 700 further includes a second receiving unit, which may be configured to receive a first instruction sent by the network device, where the first instruction is used to trigger the first terminal device to send the capability parameter.

Optionally, the terminal device 700 further includes a third receiving unit, which may be configured to receive second information sent by the network device, where the second information is used by the first terminal device to determine a resource allocation strategy for executing the first training mode, and the second information is determined based on capability parameters of a plurality of terminal devices for training the first model.

Optionally, the resource allocation strategy is used to determine an uplink transmission power, an energy consumption budget, and/or a processor frequency for executing the first training mode by the first terminal device.

Optionally, the first model includes an encoder model and a decoder model, and the plurality of training modes include: distributed training in which a plurality of terminal devices separately train the encoder model and the decoder model; and centralized training in which the network device trains the decoder model.

Optionally, when the first training mode is the distributed training, the terminal device 700 further includes a third processing unit, which may be configured to train the first model based on a local data sample to obtain a first local model gradient, where the first local model gradient is aggregated with another local model gradient based on over-the-air computation.

Optionally, when the first training mode is the centralized training, the terminal device 700 further includes a fourth processing unit, which may be configured to input the local data sample into the encoder model to obtain encoded first data/an encoded first signal; and a third sending unit, which may be configured to send target data and the first data/first signal to the network device, where the target data and the first data/first signal are used by the network device to train the decoder model.

Optionally, the distributed training is used to determine an aggregated model gradient obtained after aggregating a plurality of local model gradients in a current training cycle, the centralized training is used to determine a centralized model gradient obtained after training the decoder model in the current training cycle, and the aggregated model gradient and the centralized model gradient are used together to determine a second model to be trained in a next training cycle.

Optionally, the encoder model in the first model is φₜ, the decoder model in the first model is θₜ, and an encoder model φₜ₊₁ and a decoder model θₜ₊₁ in the second model are expressed as:

$${ϕ}_{t + 1} = {ϕ}_{t} - γ {\hat{g}}_{ϕ , t}^{L} ; and$$

$${θ}_{t + 1} = {θ}_{t} - \frac{γ ( {D}_{P} {\hat{g}}_{θ , t}^{L} + {D}_{W} {g}_{θ , t}^{C} )}{D} ,$$

where γ represents a training learning rate of the first model in the current training cycle, D_{P} represents a total number of data samples of all terminal devices that perform the distributed training, D_{W} represents a total number of data samples of all terminal devices that perform the centralized training,

$$D = {D}_{P} + {D}_{W} , {\hat{g}}_{ϕ , t}^{L}$$

represents an encoder model gradient in the aggregated model gradient,

$${\hat{g}}_{θ , t}^{L}$$

represents a decoder model gradient in the aggregated model gradient, and

$${g}_{θ , t}^{C}$$

represents the centralized model gradient.

Optionally, the first model is a codec model for semantic communication.

FIG. 8 is a schematic diagram of a structure of a control apparatus of the terminal device shown in FIG. 7. When the first model is a codec model for semantic communication, the control apparatus 800 may be a control apparatus of a terminal device in a training system for a collaborative semantic codec model for semantic communication. As shown in FIG. 8, the control apparatus 800 of the terminal device may include a category classification and resource allocation module 810, a computation module 820 for collaborative model training, and a transmission module 830 for collaborative model training. A collaborative model may be a collaborative semantic codec model.

The category classification and resource allocation module 810 may be configured to control the terminal device to determine a device category by using a received grouping strategy, and allocate a central processing unit frequency and an uplink transmission power based on a central processing unit frequency and uplink transmission power allocation strategy. After completing resource allocation, each terminal device sends a resource allocation complete instruction to the base station.

The computation module 820 for collaborative model training may be configured to control a terminal device in a first terminal device group to train a global semantic codec model by using a local data sample set at an allocated central processing unit frequency, so as to obtain a local semantic codec model gradient; and may be configured to control a terminal device in a second terminal device group to extract a semantic signal of a local data sample by using a local data sample set at an allocated central processing unit frequency.

The transmission module 830 for collaborative model training may be configured to control the terminal device in the first terminal device group to send, on a same time-frequency resource at an allocated uplink transmission power, a normalized local semantic codec model gradient signal for uploading; and may be configured to control the terminal device in the second terminal device group to upload the semantic signal of the local data sample to the base station on an orthogonal time-frequency resource at an allocated uplink transmission power.

FIG. 9 is a schematic block diagram of a network device according to an embodiment of the present application. The network device 900 may be any type of network device for model training described above. The network device 900 shown in FIG. 9 includes a first sending unit 910.

The first sending unit 910 may be configured to send a first model and first information to a first terminal device, where the first information is used by the first terminal device to select a first training mode from a plurality of training modes, the plurality of training modes are used together to train the first model, and the first training mode is used by the first terminal device to perform uplink transmission and/or model training related to the first model.

Optionally, the first information is used to determine whether the first training mode includes centralized training of a part or all of models in the first model by the network device, and The network device 900 further includes: a first receiving unit, which may be configured to, when the first training mode includes the centralized training, receive first data/a first signal used for model training and sent by the first terminal device; and a second receiving unit, which may be configured to: when the first training mode does not include the centralized training, receive a result of training the first model by the first terminal device.

Optionally, the first information includes a first threshold related to a terminal device capability, and when a capability of the first terminal device is lower than the first threshold, the first training mode includes the centralized training of a part or all of models in the first model by the network device.

Optionally, the plurality of training modes are in a one-to-one to correspondence with a plurality of terminal device groups, the first information includes a grouping strategy for the plurality of terminal device groups, and the grouping strategy is used by the first terminal device to determine the first training mode based on a terminal device group to which the first terminal device belongs.

Optionally, the first terminal device is one of a plurality of terminal devices for training the first model, and the grouping strategy is determined based on capabilities and/or channel coefficients of the plurality of terminal devices.

Optionally, the network device 900 further includes a third receiving unit, which may be configured to receive a capability parameter sent by the first terminal device, and the capability parameter includes one or more of the following: a number of floating-point operations of the first terminal device, a local data sample quantity of the first terminal device, a maximum processor frequency of the first terminal device, a maximum uplink transmission power of the first terminal device, and a maximum energy consumption budget of the first terminal device.

Optionally, the network device 900 further includes a second sending unit, which may be configured to send a first instruction to the first terminal device, where the first instruction is used to trigger the first terminal device to send the capability parameter.

Optionally, the network device 900 further includes a third sending unit, which may be configured to send second information to the first terminal device, where the second information is used by the first terminal device to determine a resource allocation strategy for executing the first training mode, and the second information is determined based on capability parameters of a plurality of terminal devices for training the first model.

Optionally, the resource allocation strategy is used to determine an uplink transmission power, an energy consumption budget, and/or a processor frequency for executing the first training mode by the first terminal device.

Optionally, the first model includes an encoder model and a decoder model, and the plurality of training modes include: distributed training in which a plurality of terminal devices separately train the encoder model and the decoder model; and centralized training in which the network device trains the decoder model.

Optionally, when the first training mode is the distributed training, the network device 900 further includes a fourth receiving unit, which may be configured to receive a first local model gradient sent by the first terminal device, where the first local model gradient is aggregated with another local model gradient based on over-the-air computation.

Optionally, when the first training mode is the centralized training, the network device 900 further includes: a fifth receiving unit, which may be used to receive target data and encoded first data/an encoded first signal sent by the first terminal device; and a processing unit, which may be configured to train the decoder model based on the target data and the first data/first signal.

Optionally, the network device 900 further includes: a first determining unit, which may be configured to determine an aggregated model gradient obtained after aggregating a plurality of local model gradients in a current training cycle; a second determining unit, which may be configured to determine a centralized model gradient obtained after training the decoder model in the current training cycle; and a third determining unit, which may be configured to determine, based on the aggregated model gradient and the centralized model gradient, a second model used for a next training cycle.

Optionally, the encoder model in the first model is φₜ, the decoder model in the first model is θₜ, and an encoder model φₜ₊₁ and a decoder model θₜ₊₁ in the second model are expressed as:

$${ϕ}_{t + 1} = {ϕ}_{t} - γ {\hat{g}}_{ϕ , t}^{L} ; and$$

$${θ}_{t + 1} = {θ}_{t} - \frac{γ ( {D}_{P} {\hat{g}}_{θ , t}^{L} + {D}_{W} {g}_{θ , t}^{C} )}{D} ,$$

where γ represents a training learning rate of the first model in the current training cycle, D_{P} represents a total number of data samples of all terminal devices that perform the distributed training, D_{W} represents a total number of data samples of all terminal devices that perform the centralized training,

$$D = {D}_{P} + {D}_{W} , {\hat{g}}_{ϕ , t}^{L}$$

represents an encoder model gradient in the aggregated model gradient,

$${\hat{g}}_{θ , t}^{L}$$

represents a decoder model gradient in the aggregated model gradient, and

$${g}_{θ , t}^{C}$$

represents the centralized model gradient.

Optionally, the first model is a codec model for semantic communication.

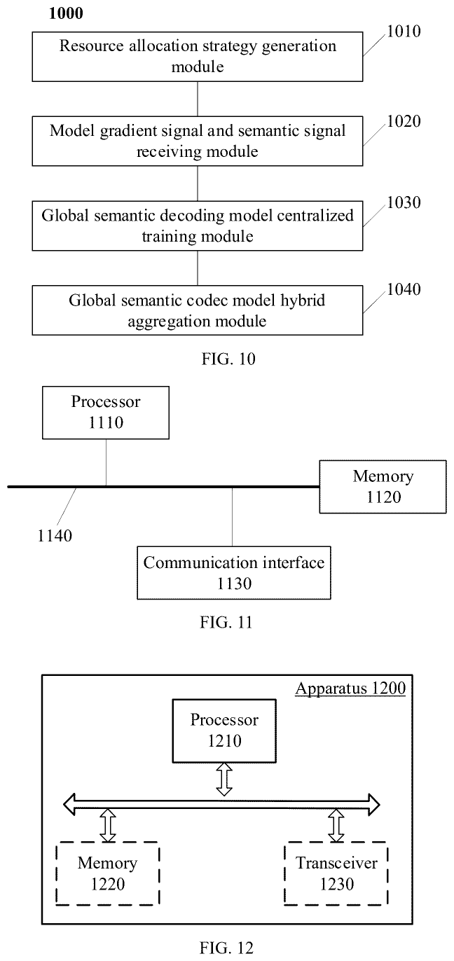

FIG. 10 is a schematic diagram of a structure of a control apparatus of the network device shown in FIG. 9. When the first model is a codec model for semantic communication, a control apparatus 1000 may be a control apparatus of a base station in a training system for a collaborative semantic codec model for semantic communication. As shown in FIG. 10, the control apparatus 1000 may include a resource allocation strategy generation module 1010, a model gradient signal and semantic signal receiving module 1020, a global semantic decoder model centralized training module 1030, and a global semantic codec model hybrid aggregation module 1040.

The resource allocation strategy generation module 1010 may be configured to broadcast a resource data collection instruction (that is, a first instruction) to each terminal device, and generate a terminal device grouping and resource allocation strategy.

The model gradient signal and semantic signal receiving module 1020 may be configured to receive a federated learning-based aggregated semantic codec model gradient from a first terminal device group and a wireless semantic signal and target data from a second terminal device group.

The global semantic decoder model centralized training module 1030 may be configured to perform centralized training of a global semantic decoder model by using the wireless semantic signal and the target data received from the second terminal device group.

The global semantic codec model hybrid aggregation module 1040 may be configured to perform hybrid aggregation by using the received federated learning-based aggregated semantic codec model gradient and a trained centralized semantic decoder model gradient, to obtain a global semantic codec model.

Optionally, a global semantic encoder model may be updated by a federated learning-based aggregated semantic encoder model gradient, and a global semantic decoder model may be updated by hybrid aggregation of a federated learning-based aggregated semantic decoder model gradient and a centralized semantic decoder model gradient.

FIG. 11 is a schematic diagram of a structure of an electronic device according to an embodiment of the present application. The electronic device is configured to implement any step in the model training method described above. The following uses a collaborative semantic codec model for semantic communication as an example for description. As shown in FIG. 11, the structure of the electronic device includes a processor 1110, a memory 1120, a communications interface 1130, and a communications bus 1140.

The processor 1110 may be configured to execute a program stored in the memory 1120 to implement any step in the procedure of the training mechanism for the collaborative semantic codec model for semantic communication provided in the foregoing embodiments of the present application.

In embodiments of the present application, the processor 1110 may be a general-purpose processor such as a CPU or a network processor (network processor, NP), or may be another general-purpose processor or dedicated processor such as a digital signal processor (digital signal processor, DSP), an application-specific integrated circuit (application-specific integrated circuit, ASIC), a field programmable gate array (field programmable gate array, FPGA) or another programmable logic device, a discrete gate or transistor logic device, or a discrete hardware component. The general-purpose processor may be a microprocessor, or the processor may be any conventional processor or the like.

The memory 1120 may be configured to store a program related to training of a collaborative semantic codec model for semantic communication.

In this embodiment of the present application, the memory 1120 may be a random access memory (random access memory, RAM), and may also include a non-volatile memory (non-volatile memory, NVM), such as at least one disk storage. Optionally, the memory may alternatively be at least one storage apparatus located far away from the processor describe above. This is not specifically limited in embodiments of the present application.

The communications bus 1140 may be configured to implement mutual communication between the processor 1110, the memory 1120, and the communications interface 1130.

In embodiments of the present application, the communications bus 1140 may be a peripheral component interconnect (peripheral component interconnect, PCI) bus, an extended industry standard architecture (extended industry standard architecture, EISA) bus, and or the like. The communications bus may be classified into an address bus, a data bus, a control bus, and the like. For ease of representation, only one thick line is used to represent the communication bus in the figure, but this does not mean that there is only one bus or only one type of bus. This is not specifically limited in embodiments of the present application.

The communications interface 1130 may be used for communication between the electronic device 1100 and another device. The another device includes but is not limited to: maintenance device, a management device, and the like for training of a collaborative semantic codec model for semantic communication. This is not specifically limited in embodiments of the present application.

In this embodiment of the present application, the communications interface 1130 may be an interface circuit for direct digital communication between a computer system and another system, and usually includes a serial communications interface and a parallel communications interface. The serial communications interface is, for example, an asynchronous transmission protocol standard interface (EIA-RS-232, RS232) or a universal serial bus (Universal Serial Bus, USB). The parallel communications interface is, for example, a peripheral component interconnect express (peripheral component interconnect express, PCI Express) apparatus. This is not specifically limited in embodiments of the present application.

FIG. 12 is a schematic structural diagram of a communication apparatus according to an embodiment of the present application. Dashed lines in FIG. 12 indicate that a unit or module is optional. The apparatus 1200 may be configured to implement a method described in the foregoing method embodiments. The apparatus 1200 may be a chip, a terminal device, or a network device.

The apparatus 1200 may include one or more processors 1210. The processor 1210 may support the apparatus 1200 to implement a method described in the foregoing method embodiments. Similar to the processor 1110, the processor 1210 may also be a general-purpose processor or a dedicated processor, and details are not described again. Refer to the description of the processor 1110. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1200 may further include one or more memories 1220. The memory 1220 stores a program, and the program may be executed by the processor 1210, so that the processor 1210 executes a method described in the foregoing method embodiments. The memory 1220 may be separate from or integrated into the processor 1210.

The apparatus 1200 may further include a transceiver 1230. The processor 1210 may communicate with another device or chip through the transceiver 1230. For example, the processor 1210 may transmit data to and receive data from another device or chip through the transceiver 1230.

An embodiment of the present application further provides a computer-readable storage medium for storing a program. The computer-readable storage medium may be applied to a terminal device or a network device provided in embodiments of the present application, and the program causes a computer to execute a method executed by the terminal device or the network device in various embodiments of the present application.

The computer-readable storage medium may be any usable medium that a computer can read, or a data storage device such as a server or a data center that integrates one or more usable media. The usable medium may be a magnetic medium, an optical medium, a semiconductor medium, or the like. Examples of the computer-readable storage media include, but are not limited to: phase-change memory (phase-change random access memory, PRAM), static random access memory (static random access memory, SRAM), dynamic random access memory (dynamic random access memory, DRAM), another type of random access memory (random access memory, RAM), read only memory (read only memory, ROM), electrically erasable programmable read only memory (electrically erasable programmable read only memory, EEPROM), flash memory or another memory technology, compact disc-read only memory (compact disc-read only Memory, CD-ROM), solid state disk (solid state disk, SSD), digital video disc (digital video disc, DVD) or another optical storage, magnetic cassette tape, magnetic tape/disk storage or another magnetic storage device, or any other non-transmission media. As defined in this specification, the computer-readable media does not include a temporary computer-readable medium (transitory media), such as modulated data signal and a carrier wave.

The computer-readable medium includes permanent and non-permanent, removable and non-removable media, and may be implemented by any method or technology for storage of information. The computer-readable medium may be configured to store information that may be accessed by a computing device. The information may be computer-readable instructions, data structures, program modules, or other data.

An embodiment of the present application further provides a readable storage medium, storing a program or instructions. When the program or instructions are executed by a processor, various processes in the foregoing method embodiment can be implemented or a same technical effect can be achieved. To avoid repetition, details are not described herein again. Optionally, when the program or instructions are executed by the processor, any step of the procedure of the training mechanism for the collaborative semantic codec model for semantic communication described above can be implemented.

An embodiment of the present application further provides a computer program product. The computer program product includes a program. The computer program product may be applied to a terminal device or a network device provided in embodiments of the present application, and the program causes a computer to execute a method executed by the terminal or the network device in various embodiments of the present application. Optionally, the computer program product includes instructions that, when executed on a computer, cause the computer to execute any step of the procedure of the training mechanism for the collaborative semantic codec model for semantic communication described above.

Embodiments in this specification are described in a related manner, for the same or similar parts between embodiments, reference may be made to each other, and each embodiment focuses on differences from other embodiments. In particular, descriptions of the apparatus embodiment, electronic device embodiment, computer-readable storage medium embodiment, and computer program product embodiment are relatively simple, because they are basically similar to those in the method embodiments. Therefore, for related parts, refer to partial description of the method embodiments.

All or some of the foregoing embodiments may be implemented by using software, hardware, firmware, or any combination thereof. When software is used to implement the embodiments, all or a part of the embodiments may be implemented in a form of a computer program product. The computer program product includes one or more computer instructions.

When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner.

An embodiment of the present application further provides a computer program. The computer program may be applied to a terminal device or a network device provided in embodiments of the present application, and the computer program causes a computer to execute a method executed by the terminal or the network device in various embodiments of the present application.

The terms “system” and “network” in the present application may be used interchangeably. In addition, the terms used in the present application are only used to explain the specific embodiments of the present application, and are not intended to limit the present application.

Relational terms such as “first”, “second”, and “third” in the present application are merely used to distinguish one entity or operation from another entity or operation, but do not necessarily require or imply any such actual relationship or order between these entities or operations.

It should be understood that the term “comprise”, “include”, or any other variant thereof is intended to cover a non-exclusive inclusion, so that a process, a method, an article, or a terminal device that includes a list of elements not only includes those elements but also includes other elements that are not expressly listed, or further includes elements inherent to such a process, method, article, or device. Without being subject to further limitations, an element defined by a phrase “including one . . . ” does not exclude presence of other identical elements in the process, method, article, or device that includes the element.

In embodiments of the present application, “indicate” mentioned herein may refer to a direct indication, or may refer to an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “corresponding” may mean that there is a direct or indirect correspondence between the two, or may mean that there is an association relationship between the two, which may also be a relationship such as indicating and being indicated, or configuring and being configured.

In embodiments of the present application, the “protocol” may refer to a standard protocol in the communications field, and may include, for example, an LTE protocol, an NR protocol, and a related protocol applied to a future communication system, which is not limited in the present application.

In embodiments of the present application, determining B based on A does not mean determining B based on only A, but instead B may be determined based on A and/or other information.

In embodiments of the present application, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

In embodiments of the present application, sequence numbers of the foregoing processes do not mean execution sequences. The execution sequences of the processes should be determined based on functions and internal logic of the processes, and shall not be construed as any limitation on the implementation processes of embodiments of the present application.

In several embodiments provided in the present application, it should be understood that the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. Indirect couplings or communication connections between apparatuses or units may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

According to the description of the foregoing implementations, a person skilled in the art may clearly understand that the foregoing embodiments may be implemented by software in addition to a necessary universal hardware platform or by hardware only. In most cases, the former is a more preferred implementation. Based on such an understanding, the technical solutions of the present application essentially, or the part contributing to the conventional technologies may be implemented in a form of a software product. The computer software product is stored in a storage medium (for example, a ROM/RAM, a magnetic disk, or an optical disc), and includes a plurality of instructions for instructing a service classification device (which may be a mobile phone, a computer, a server, an air conditioner, a network device, or the like) to perform methods described in embodiments of the present application.

The foregoing descriptions are merely specific implementations of the present application, but the protection scope of the present application is not limited thereto. Any modification, equivalent substitution, or improvement readily figured out by a person skilled in the art within the technical scope disclosed in the present application shall fall within the protection scope of the present application. Therefore, the protection scope of the present application shall be subject to the protection scope of the claims.

What is claimed is:

1. A model training method, comprising:
receiving, by a first terminal device, a first model and first information from a network device; and
selecting, by the first terminal device, a first training mode from a plurality of training modes based on the first information;
wherein the plurality of training modes are used together to train the first model, and the first training mode is used by the first terminal device to perform at least one of uplink transmission or model training related to the first model.

2. The method according to claim 1, wherein the first information is used to determine whether the first training mode comprises centralized training of a part or all of models in the first model by the network device, and the method further comprises:
when the first training mode comprises the centralized training, sending, by the first terminal device to the network device, first data or a first signal used for the centralized training; or
when the first training mode does not comprise the centralized training, training, by the first terminal device, the first model.

3. The method according to claim 1, wherein the first information comprises a first threshold related to a terminal device capability, and when a capability of the first terminal device is lower than the first threshold, the first training mode comprises the centralized training of a part or all of models in the first model by the network device.

4. The method according to claim 1, wherein the plurality of training modes are in a one-to-one to correspondence with a plurality of terminal device groups, the first information comprises a grouping strategy for the plurality of terminal device groups, and the grouping strategy is used by the first terminal device to determine the first training mode based on a terminal device group to which the first terminal device belongs.

5. The method according to claim 4, wherein the first terminal device is one of a plurality of terminal devices for training the first model, and the grouping strategy is determined based on at least one of capabilities or channel coefficients of the plurality of terminal devices.

6. The method according to claim 1, wherein the method further comprises:
sending, by the first terminal device, a capability parameter to the network device, wherein the capability parameter comprises one or more of the following:
a number of floating-point operations of the first terminal device;
a local data sample quantity of the first terminal device;
a maximum processor frequency of the first terminal device;
a maximum uplink transmission power of the first terminal device; or
a maximum energy consumption budget of the first terminal device.

7. The method according to claim 6, wherein the method further comprises:
receiving, by the first terminal device, a first instruction sent by the network device, wherein the first instruction is used to trigger the first terminal device to send the capability parameter.

8. The method according to claim 1, wherein the method further comprises:
receiving, by the first terminal device, second information from the network device, wherein the second information is used by the first terminal device to determine a resource allocation strategy for executing the first training mode, and the second information is determined based on capability parameters of a plurality of terminal devices for training the first model.

9. The method according to claim 8, wherein the resource allocation strategy is used to determine at least one of uplink transmission power, an energy consumption budget, or a processor frequency for executing the first training mode by the first terminal device.

10. The method according to claim 1, wherein the first model comprises an encoder model and a decoder model, and the plurality of training modes comprise:
distributed training in which a plurality of terminal devices separately train the encoder model and the decoder model; and
centralized training on the decoder model by the network device.

11. The method according to claim 10, wherein when the first training mode is the distributed training, the method further comprises:
training, by the first terminal device, the first model based on a local data sample to obtain a first local model gradient, wherein the first local model gradient is aggregated with another local model gradient based on over-the-air computation.

12. The method according to claim 10, wherein when the first training mode is the centralized training, the method further comprises:
inputting, by the first terminal device, a local data sample into the encoder model to obtain encoded first data or an encoded first signal; and
sending, by the first terminal device, target data and the first data or first signal to the network device, wherein the target data and the first data or first signal are used by the network device to train the decoder model.

13. The method according to claim 10, wherein the distributed training is used to determine an aggregated model gradient obtained after aggregating a plurality of local model gradients in a current training cycle, the centralized training is used to determine a centralized model gradient obtained after training the decoder model in the current training cycle, and the aggregated model gradient and the centralized model gradient are used together to determine a second model to be trained in a next training cycle.

14. The method according to claim 13, wherein the encoder model in the first model is φₜ, the decoder model in the first model is θₜ, and an encoder model φₜ₊₁ and a decoder model θₜ₊₁ in the second model are expressed as:
$${ϕ}_{t + 1} = {ϕ}_{t} - γ {\hat{g}}_{ϕ , t}^{L} ; and$$
$${θ}_{t + 1} = {θ}_{t} - \frac{γ ( {D}_{P} {\hat{g}}_{θ , t}^{L} + {D}_{W} {g}_{θ , t}^{C} )}{D} ,$$
wherein γ represents a training learning rate of the first model in the current training cycle, D_{P} represents a total number of data samples of terminal devices that perform the distributed training, D_{W} represents a total number of data samples of terminal devices that perform the centralized training,
$$D = {D}_{P} + {D}_{W} , {\hat{g}}_{ϕ , t}^{L}$$
represents an encoder model gradient in the aggregated model gradient,
$${\hat{g}}_{θ , t}^{L}$$
represents a decoder model gradient in the aggregated model gradient, and
$${g}_{θ , t}^{C}$$
represents the centralized model gradient.

15. The method according to claim 1, wherein the first model is a codec model for semantic communication.

16. A model training method, comprising:
sending, by a network device, a first model and first information to a first terminal device; and
receiving, from the first terminal device, uplink transmission based on a first training mode selected based on the first information.

17. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving a first model and first information from a network device; and
selecting a first training mode from a plurality of training modes based on the first information;
wherein the plurality of training modes are used together to train the first model, and the first training mode is used by the apparatus to perform at least one of uplink transmission or model training related to the first model.

18. The apparatus according to claim 17, wherein the first information is used to determine whether the first training mode comprises centralized training of a part or all of models in the first model by the network device, and the operations further comprise:
when the first training mode comprises the centralized training, sending, to the network device, first data or a first signal used for the centralized training; or
when the first training mode does not comprise the centralized training, training the first model.

19. The apparatus according to claim 17, wherein the first information comprises a first threshold related to a terminal device capability, and when a capability of the apparatus is lower than the first threshold, the first training mode comprises the centralized training of a part or all of models in the first model by the network device.

20. The apparatus according to claim 17, wherein the plurality of training modes are in a one-to-one to correspondence with a plurality of terminal device groups, the first information comprises a grouping strategy for the plurality of terminal device groups, and the grouping strategy is used by the apparatus to determine the first training mode based on a terminal device group to which the apparatus belongs.
